(19) United States
(12) Patent Application Publication
(10) Pub. No.: US 2013/0176657 A1
(43) Pub. Date: Jul. 11, 2013

(54) ELECTROMECHANICAL SYSTEMS VARIABLE CAPACITANCE ASSEMBLY

(71) Applicants: Je-Hsiung LAN, San Diego, CA (US); Evgeni Petrovich GOUSEV, Saratoga, CA (US); Sang-June PARK, San Diego, CA (US); Wenyue ZHANG, San Jose, CA (US)

(72) Inventors: Je-Hsiung LAN, San Diego, CA (US); Evgeni Petrovich GOUSEV, Saratoga, CA (US); Sang-June PARK, San Diego, CA (US); Wenyue ZHANG, San Jose, CA (US)

(73) Assignee: QUALCOMM MEMS TECHNOLOGIES, INC., San Diego, CA (US)

(21) Appl. No.: 13/348,541

(22) Filed: Jan. 11, 2012

(51) Int. Cl. H01G 5/38; B05D 5/12

(52) U.S. Cl. 361/277; 427/79

(57) ABSTRACT

This disclosure provides systems, methods and apparatus for a variable capacitance apparatus. In one aspect, an apparatus includes a plurality of electromechanical systems varactors connected in parallel. Each of the plurality of electromechanical systems varactors includes a first, a second, and a third metal layer. The first metal layer includes a first bias electrode. The second metal layer is spaced apart from the first metal layer to define a first air gap, and includes a first radio frequency electrode. A third metal layer is spaced apart from the second metal layer to define a second air gap, and includes a second radio frequency electrode and a second bias electrode. The second bias electrode of each of the plurality of electromechanical systems varactors has a different projected area perpendicular to a surface of the second metal layer and onto the surface of the second metal layer.

### TECHNICAL FIELD

This disclosure relates generally to electromechanical systems (EMS) devices and more particularly to EMS variable capacitance devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems (EMS) device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

EMS devices also may be used to implement various radio frequency (RF) circuit components. For example, one type of EMS RF circuit component is an EMS variable capacitance device, also referred to as an EMS varactor or a RF-EMS varactor. An EMS varactor may be included in various circuits and RF systems such as tunable filters, tunable antennas, tunable matching networks, etc.

### SUMMARY

The systems, methods and devices of the disclosure each have several innovative aspects, no single one of which is solely responsible for the desirable attributes disclosed herein.

One innovative aspect of the subject matter described in this disclosure can be implemented in a variable capacitance apparatus. The apparatus may include a plurality of electromechanical systems varactors connected in parallel. Each of the plurality of electromechanical systems varactors may include a first metal layer, a second metal layer, and a third metal layer. The first metal layer may include a first bias electrode. The second metal layer may be spaced apart from the first metal layer, with the second metal layer and the first metal layer defining a first air gap. The second metal layer may include a first radio frequency electrode. The third metal layer may be spaced apart from the second metal layer, with the third metal layer and the second metal layer defining a second air gap. The third metal layer may include a second radio frequency electrode and a second bias electrode. The second bias electrode of each of the plurality of electromechanical systems varactors may have a different projected area perpendicular to a surface of the second metal layer and onto the surface of the second metal layer.

In some implementations, when a first direct current voltage is applied to the first bias electrode of each of the plurality of electromechanical systems varactors, the first radio frequency electrode of each of the plurality of electromechanical systems varactors is configured to mechanically move to a first state. Each of the plurality of electromechanical systems varactors may be characterized by a different second direct current voltage applied to the second bias electrode to mechanically move the first radio frequency electrode from the first state to a second state.

In some implementations, the apparatus may further include a first radio frequency terminal electrically connected to the first radio frequency electrode of each of the plurality of electromechanical systems varactors, a second radio frequency terminal electrically connected to the second radio frequency electrode of each of the plurality of electromechanical systems varactors, a first bias terminal electrically connected to the first bias electrode of each of the plurality of electromechanical systems varactors, and a second bias terminal electrically connected to the second bias electrode of each of the plurality of electromechanical systems varactors. In some implementations, the second radio frequency terminal may be configured to receive a radio frequency signal, and the first radio frequency terminal may configured to vary a capacitance observed by the radio frequency signal received by the second radio frequency terminal. The first bias terminal may be configured to receive a first direct current voltage, and the second bias terminal may be configured to receive a second direct current voltage.

Another innovative aspect of the subject matter described in this disclosure can be implemented in a variable capacitance apparatus. The apparatus may include a plurality of electromechanical systems varactors connected in parallel. Each of the plurality of electromechanical systems varactors may include a first metal layer, a second metal layer, and a third metal layer. The first metal layer may include a first bias electrode. The second metal layer may be spaced apart from the first metal layer, with the second metal layer and the first metal layer defining a first air gap. The second metal layer may include a first radio frequency electrode. The third metal layer may be spaced apart from the second metal layer, with the third metal layer and the second metal layer defining a second air gap. The third metal layer may include a second radio frequency electrode and a second bias electrode. The second bias electrode of each of the plurality of electromechanical systems varactors may have a different projected area perpendicular to a surface of the second metal layer and onto the surface of the second metal layer. A first radio frequency terminal may be electrically connected to the first radio frequency electrode of each of the plurality of electromechanical systems varactors, a second radio frequency terminal may be electrically connected to the second radio frequency electrode of each of the plurality of electromechanical systems varactors, a first bias terminal may be electrically connected to the first bias electrode of each of the plurality of electromechanical systems varactors, and a second bias terminal may be electrically connected to the second bias electrode of each of the plurality of electromechanical systems varactors. When a first direct current voltage is applied to the first bias terminal, the first radio frequency electrode of each of the plurality of electromechanical systems varactors may be configured to mechanically move to a first state. Each of the plurality of electromechanical systems varactors may be characterized by a different second direct current voltage applied to the second bias terminal to mechanically move the first radio frequency electrode from the first state to a second state.

In some implementations, the second radio frequency terminal may be configured to receive a radio frequency signal, and the first radio frequency terminal may be configured to vary a capacitance observed by the radio frequency signal received by the second radio frequency terminal. In some other implementations, the first radio frequency terminal may be configured to receive a radio frequency signal, and the second radio frequency terminal may be configured to vary a capacitance observed by the radio frequency signal received by the first radio frequency terminal.

Another innovative aspect of the subject matter described in this disclosure can be implemented in a method of fabricating a variable capacitance apparatus. A first bias electrode may be formed on a substrate for one of a plurality of electromechanical systems varactors. A non-planarized first dielectric layer may be formed on the first bias electrode for the one of the plurality of electromechanical systems varactors. A first sacrificial layer may be formed on the non-planarized first dielectric layer without planarizing the first dielectric layer for the one of the plurality of electromechanical systems varactors. A first radio frequency electrode may be formed on the first sacrificial layer for the one of the plurality of electromechanical systems varactors. A second sacrificial layer may be formed on the first radio frequency electrode for the one of the plurality of electromechanical systems varactors. A second radio frequency electrode may be formed on the second sacrificial layer for the one of the plurality of electromechanical systems varactors. A second bias electrode may be formed on the second sacrificial layer for the one of the plurality of electromechanical systems varactors. The first sacrificial layer and the second sacrificial layer may be removed for the one of the plurality of electromechanical systems varactors. The second bias electrode of each of the plurality of electromechanical systems varactors may have a different projected area perpendicular to a surface of the first radio frequency electrode and onto the surface of the first radio frequency electrode.

In some implementations, a non-planarized second dielectric layer may be formed on the second bias electrode and the second radio frequency electrode for the one of the plurality of electromechanical systems varactors. In some implementations, the first dielectric layer may be formed with at least one of a physical vapor deposition process, a chemical vapor deposition process, and an atomic layer deposition process.

Another innovative aspect of the subject matter described in this disclosure can be implemented in a method of operating a variable capacitance assembly. A first direct current voltage may be applied to a first bias terminal of a variable capacitance assembly. The variable capacitance assembly may include a plurality of electromechanical systems varactors connected in parallel. The first bias terminal may be electrically connected to a first bias electrode of each of the plurality of electromechanical systems varactors. The first direct current voltage may mechanically move a first radio frequency electrode of each of the plurality of electromechanical systems varactors to a first state. After the first direct current voltage is applied, a second direct current voltage may be applied to a second bias terminal of the variable capacitance assembly. The second bias terminal may be electrically connected to a second bias electrode of each of the plurality of electromechanical systems varactors. The second direct current voltage may mechanically move the first radio frequency electrode of a first electromechanical systems varactor of the plurality of electromechanical systems varactors from the first state to a second state. After the first direct current voltage is applied, a third direct current voltage may be applied to the second bias terminal of the variable capacitance assembly. The third direct current voltage may mechanically move the first radio frequency electrode of the first electromechanical systems varactor and a second electromechanical systems varactor of the plurality of electromechanical systems varactors from the first state to the second state. Applying the second direct current voltage and the third direct current voltage may vary a capacitance between a first radio frequency terminal and a second radio frequency terminal of the variable capacitance assembly. The first radio frequency terminal may be electrically connected to the first radio frequency electrode of each of the plurality of electromechanical systems varactors, and the second radio frequency terminal may be electrically connected to a second radio frequency electrode of each of the plurality of electromechanical systems varactors.

In some implementations, the second bias electrode of each of the plurality of electromechanical systems varactors may have a different projected area perpendicular to a surface of the first radio frequency electrode and onto the surface of the first radio frequency electrode. In some implementations, an input signal may be applied to the second radio frequency terminal of the variable capacitance assembly. In some implementations, the third direct current voltage may be larger than the second direct current voltage.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a cross-sectional schematic illustration of a variable capacitance assembly.

FIGS. 10A and 10B show examples of cross-sectional schematic illustrations of an EMS varactor that may be incorporated in a variable capacitance assembly.

FIG. 11 shows an example of a top-down schematic illustration of the EMS varactor shown in FIGS. 10A and 10B.

FIGS. 12A-12C show examples of top-down schematic illustrations of second RF electrodes and second bias electrodes of EMS varactors in a variable capacitance assembly.

FIGS. 13A and 13B show examples of cross-sectional schematic illustrations of an EMS varactor that may be incorporated in a variable capacitance assembly.

FIG. 14 shows an example of a flow diagram illustrating a manufacturing process for a variable capacitance assembly including an EMS varactor.

FIG. 15 shows an example of a flow diagram illustrating a method of operation of a variable capacitance assembly.

FIGS. 16A-16D show examples of the variable capacitance assembly at various stages in the method of operation.

FIG. 17 shows an example of a graph showing the capacitance of a variable capacitance assembly versus the DC voltage applied to the second bias terminal of the variable capacitance assembly.

FIGS. 18A and 18B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

Some implementations described herein relate to a variable capacitance assembly. A variable capacitance assembly may include two or more EMS varactors. Each of the EMS varactors may include three metal layers. A first metal layer may include a first bias electrode. A second metal layer may be spaced apart from the first metal layer, and the second metal layer may include a first radio frequency (RF) electrode. The second metal layer and the first metal layer may define a first air gap. A third metal layer may be spaced apart from the second metal layer, and the third metal layer may include a second RF electrode and a second bias electrode. The third metal layer and the second metal layer may define a second air gap. The second bias electrode of each of the EMS varactors may have a different projected area perpendicular to a surface and onto the surface of the second metal layer.

The variable capacitance assembly may further include a number of terminals. A first RF terminal may be electrically connected to the first RF electrode of each of the EMS varactors. A second RF terminal may be electrically connected to the second RF electrode of each of the EMS varactors. A first bias terminal may be electrically connected to the first bias electrode of each of the EMS varactors. A second bias terminal may electrically connected to the second bias electrode of each of the EMS varactors.

In the operation of the variable capacitance assembly, a first direct current (DC) voltage may be applied to the first bias electrode of each of the EMS varactors using the first bias terminal. The first DC voltage may cause the first RF electrode of each of the EMS varactors to move to a first state. A second DC voltage may be applied to the second bias electrode of each of the EMS varactors using the second bias terminal. The second DC voltage may cause the first RF electrode of a first EMS varactor to move to a second state. A third DC voltage may be applied to the second bias electrode of each of the EMS varactors using the second bias terminal. The third DC voltage may cause the first RF electrode of the first EMS varactor and a second EMS varactor to move to the second state.

By varying the number of the EMS varactors of the variable capacitance assembly in the first state and the second state with the application of DC voltages to the first bias terminal and the second bias terminal, the capacitance between the first RF terminal and the second RF terminal of the variable capacitance assembly can be varied.

Particular implementations of the subject matter described in this disclosure can be implemented to realize one or more of the following potential advantages. The variable capacitance assemblies disclosed herein may have a higher power handling capability (e.g., about 1 milliwatt (mW) to 100 mW, about 2 Watts (W) to 4 W, or about 10 W to 50 W) than other variable capacitance assemblies due to 1) the separate bias electrodes and RF electrodes of EMS varactors in the variable capacitance assemblies, and 2) a first RF electrode being held in a first state and a second state by a first DC voltage and a second DC voltage, respectively, for EMS varactors in the variable capacitance assemblies. The variable capacitance assemblies disclosed herein also may have a small chip size due to 1) a small number of routing lines, 2) a small the number of DC bias bond pads, and 3) a smaller number of EMS varactors in the variable capacitance assemblies, compared to other variable capacitance assemblies. Other advantages may include 1) a low manufacturing cost of the variable capacitance assembly due to a simple device driving control to operate the assembly, 2) better isolation of the RF and DC paths due to one of the RF electrodes being separated into DC and RF electrodes in the EMS varactors of the variable capacitance assembly, and 3) enhanced thermal stability in capacitance due to a first RF electrode being held in a first state and a second state by a first DC voltage and a second DC voltage, respectively, for an EMS varactor in the variable capacitance assembly, which may not allow the first RF electrode to fluctuate in position with temperature.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

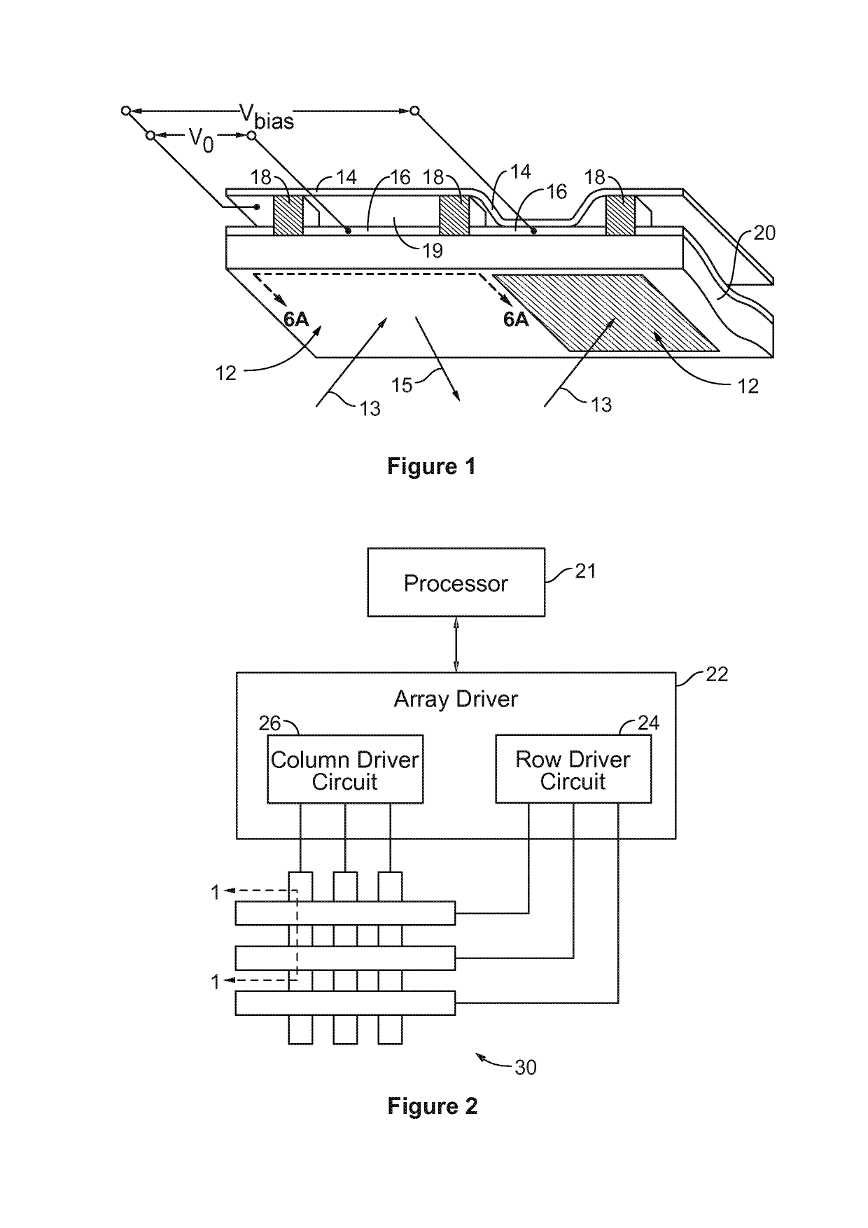

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage Vₒ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

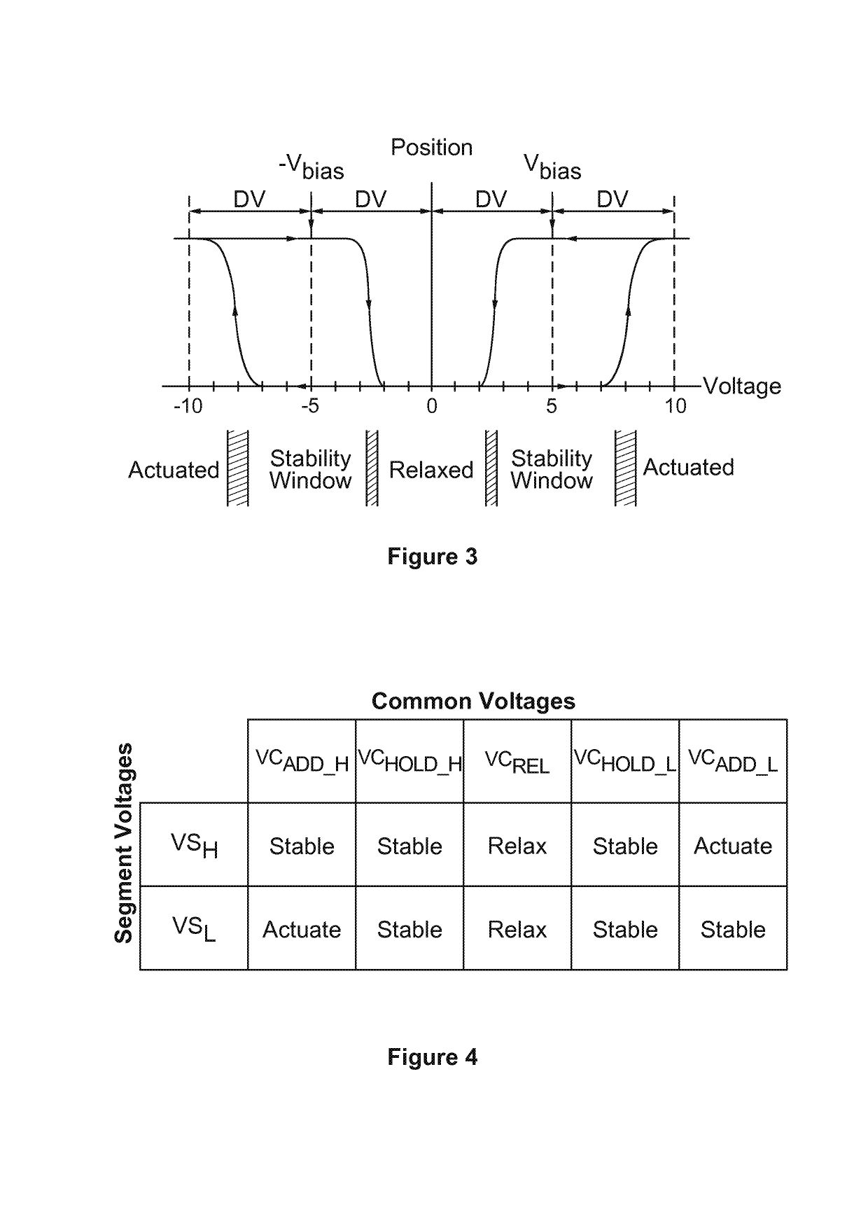

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

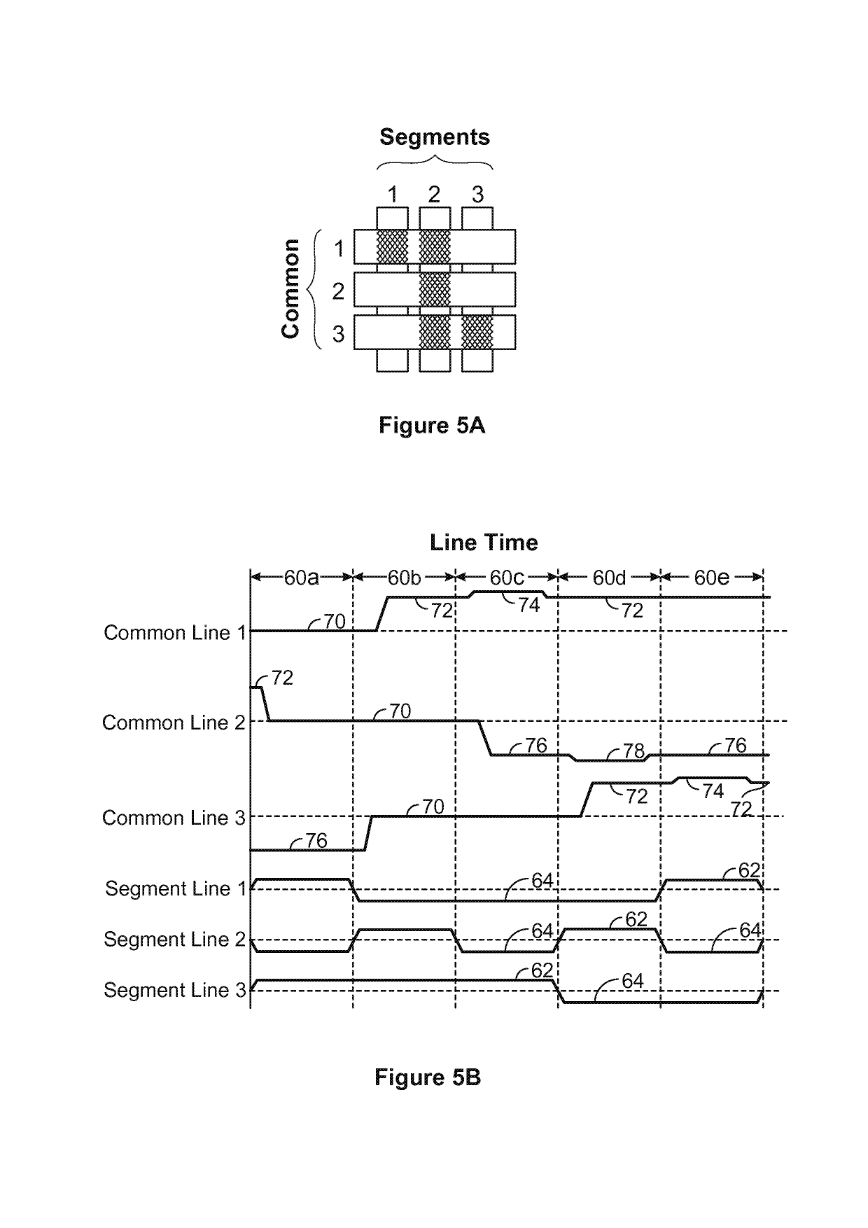

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

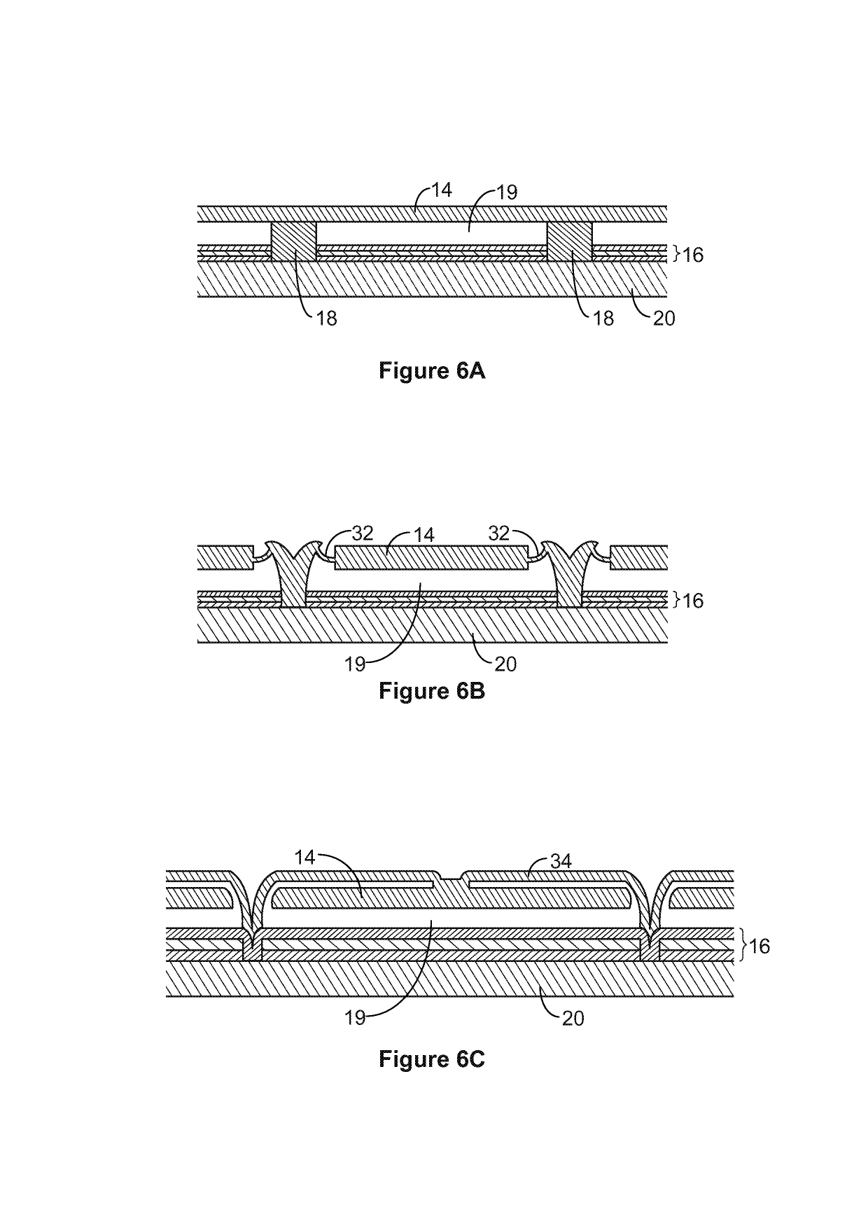

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

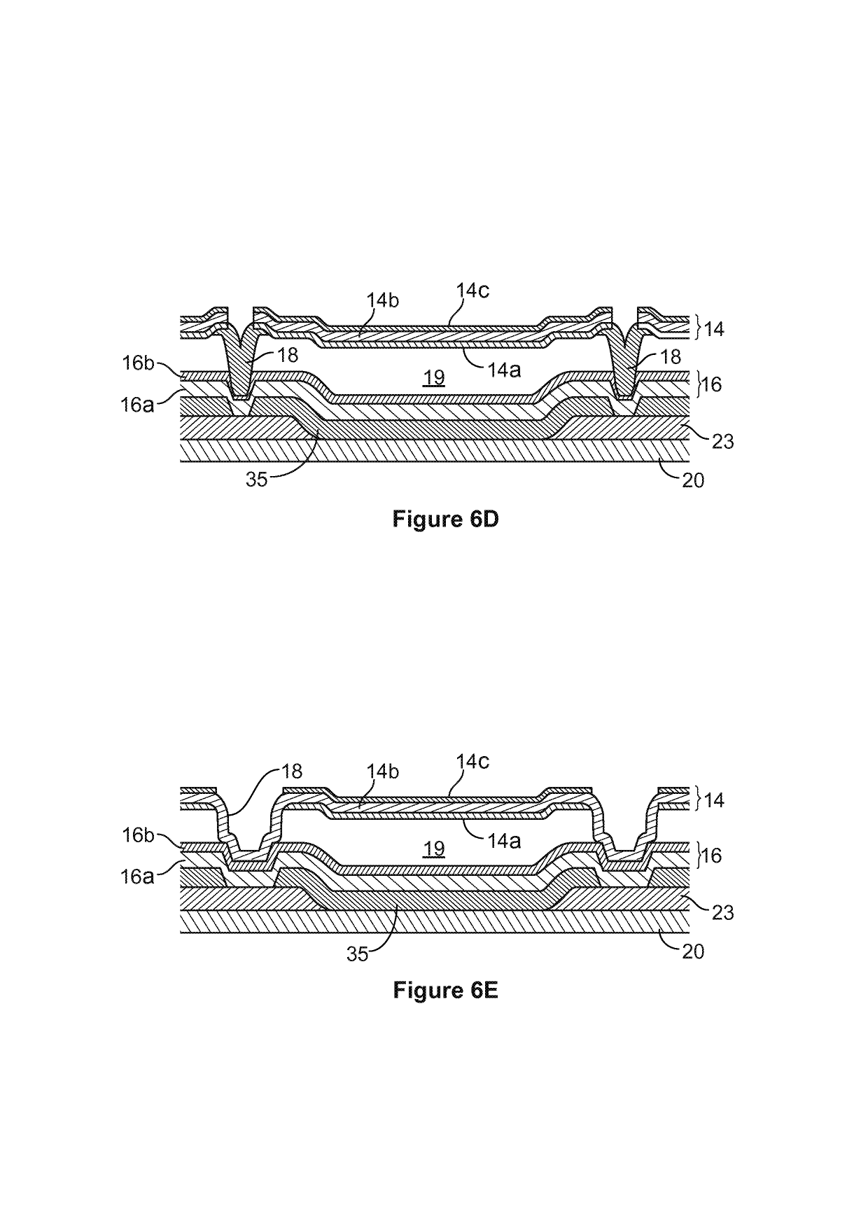

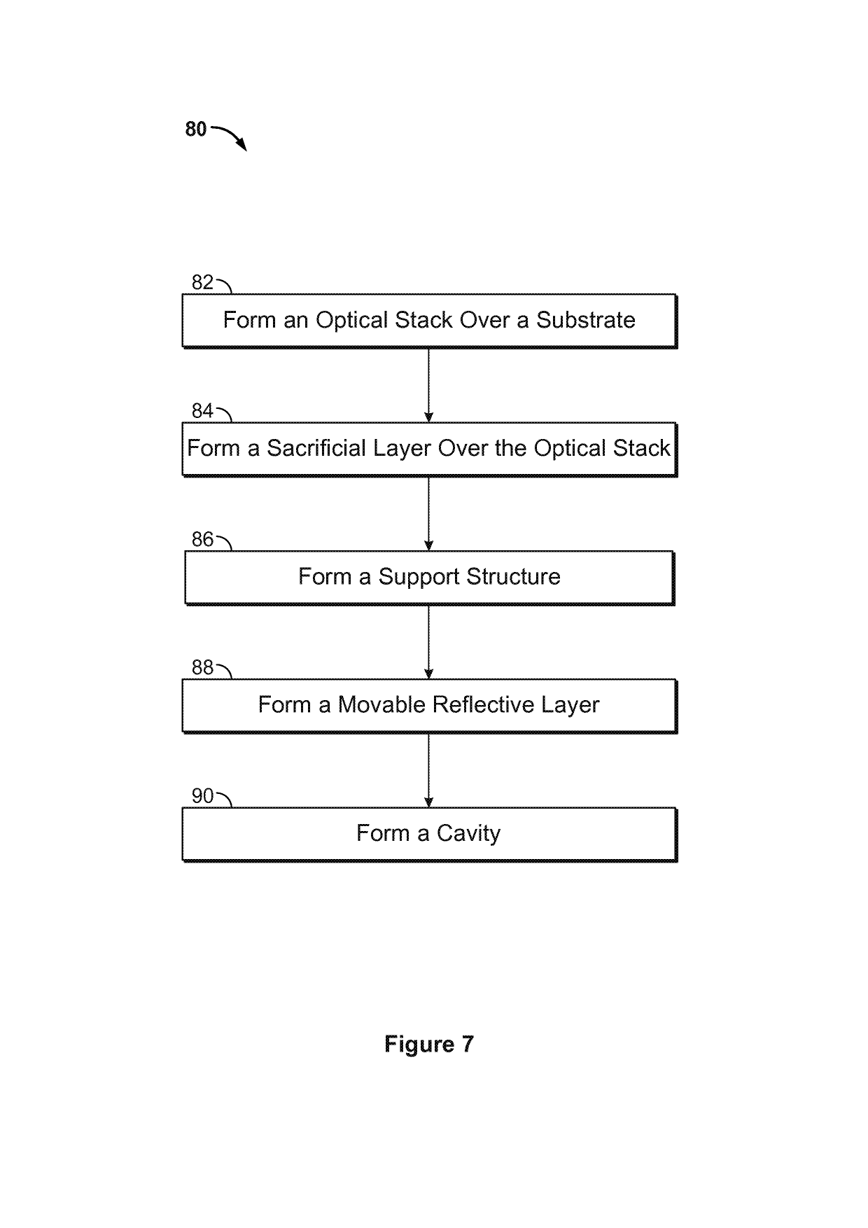

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

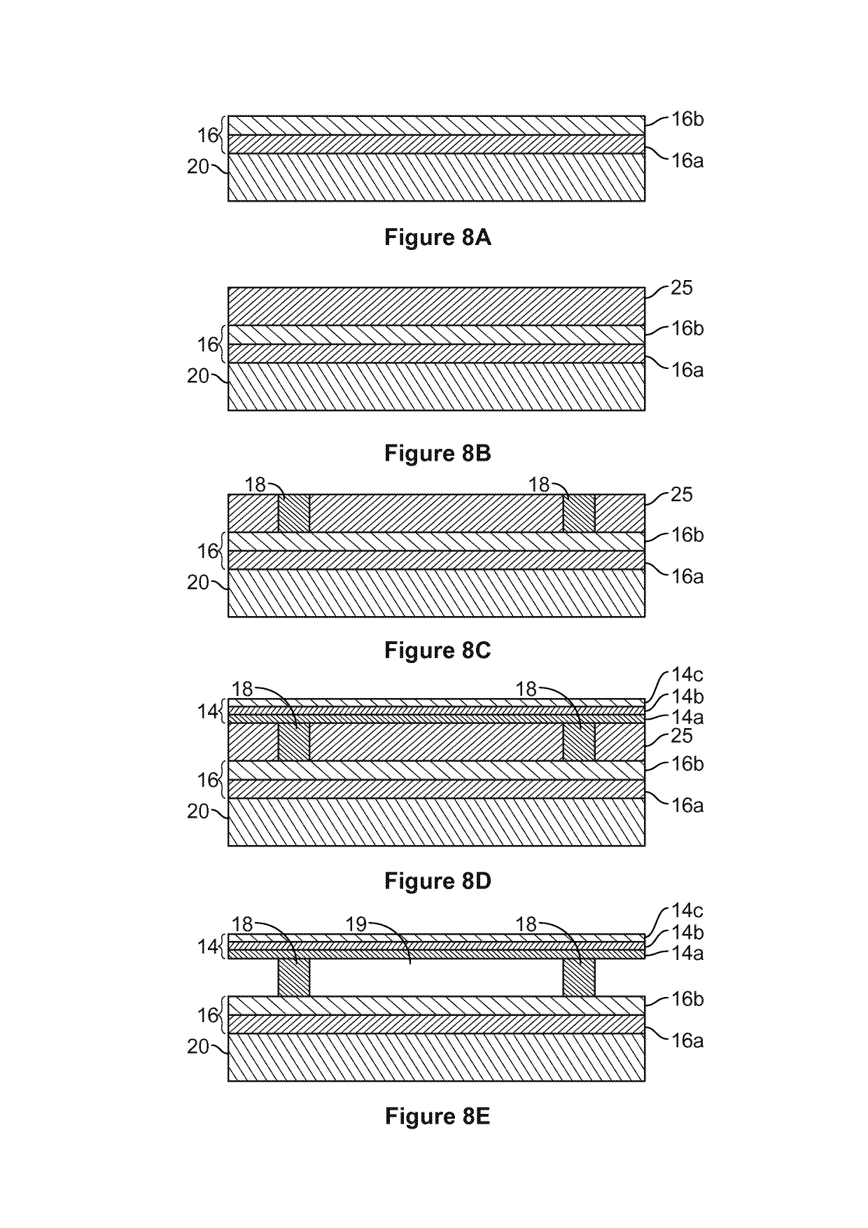

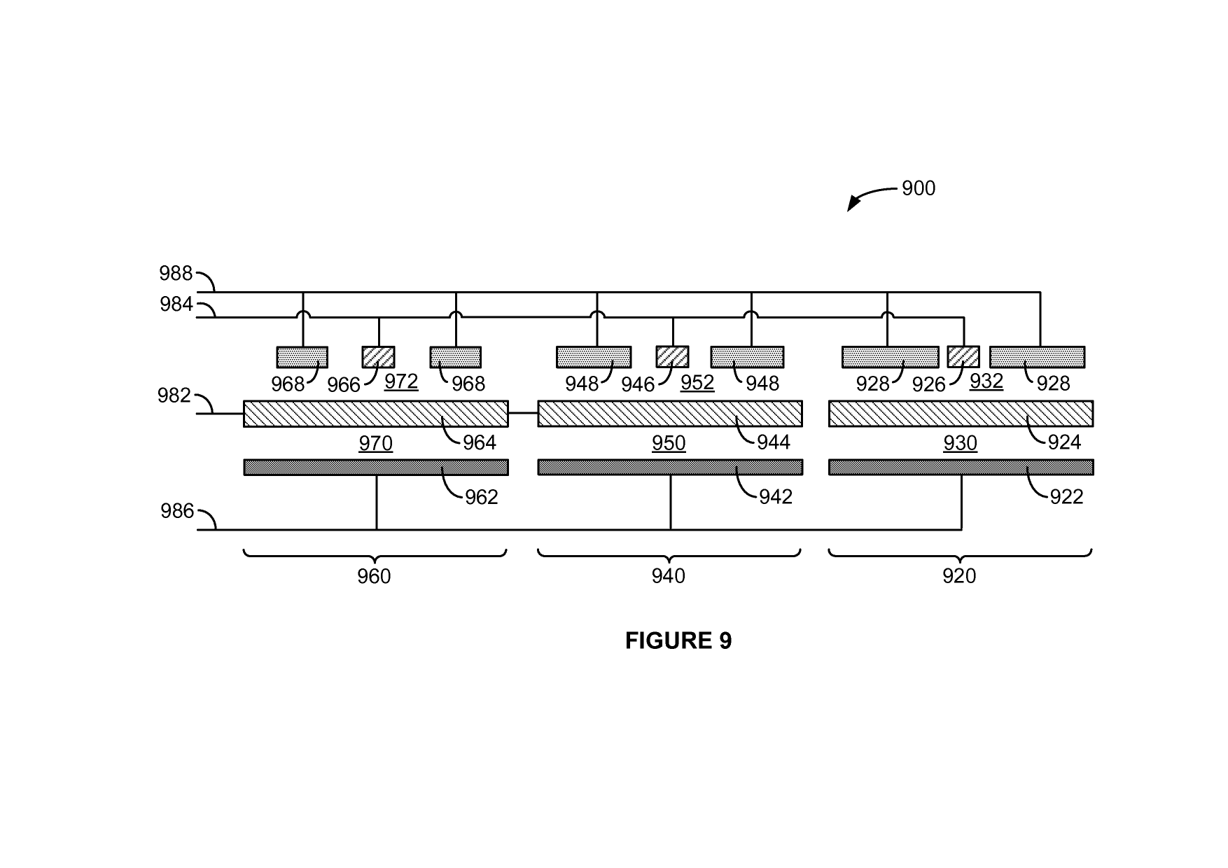

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

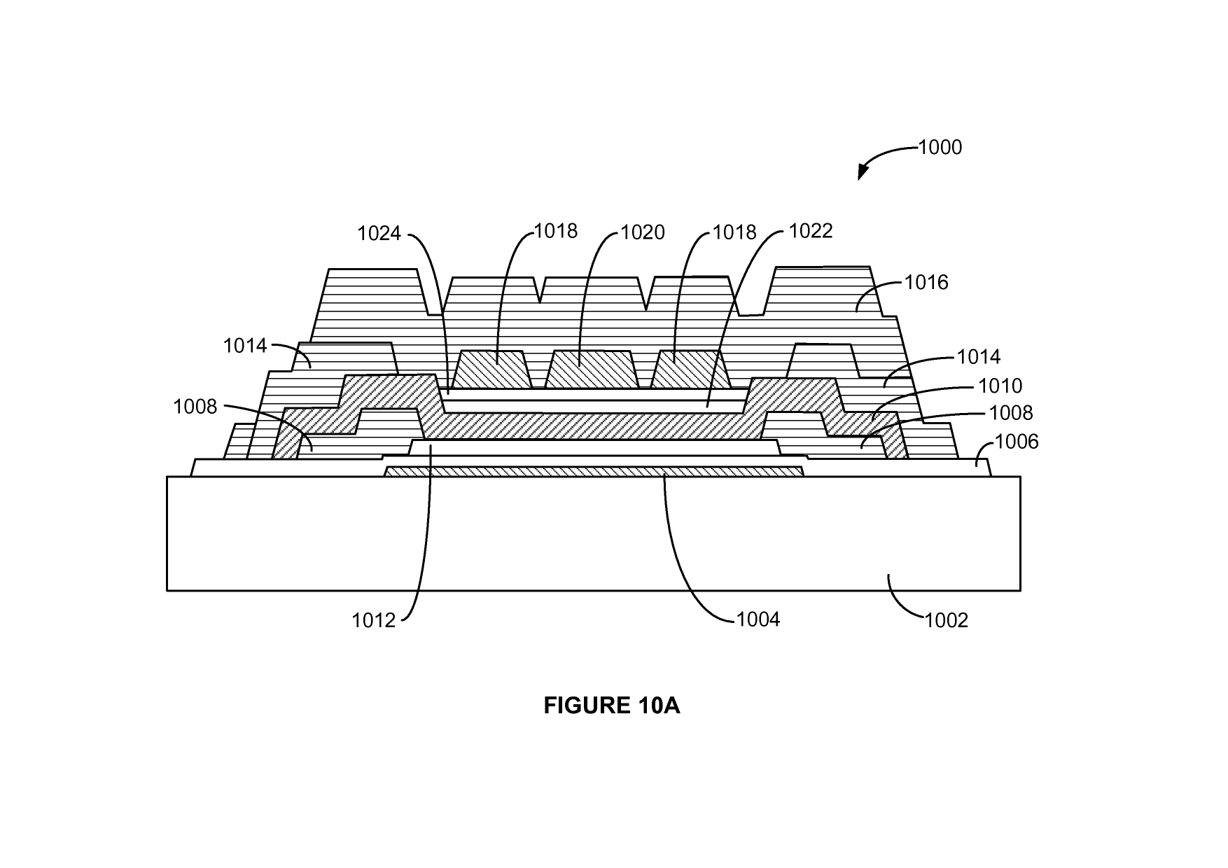

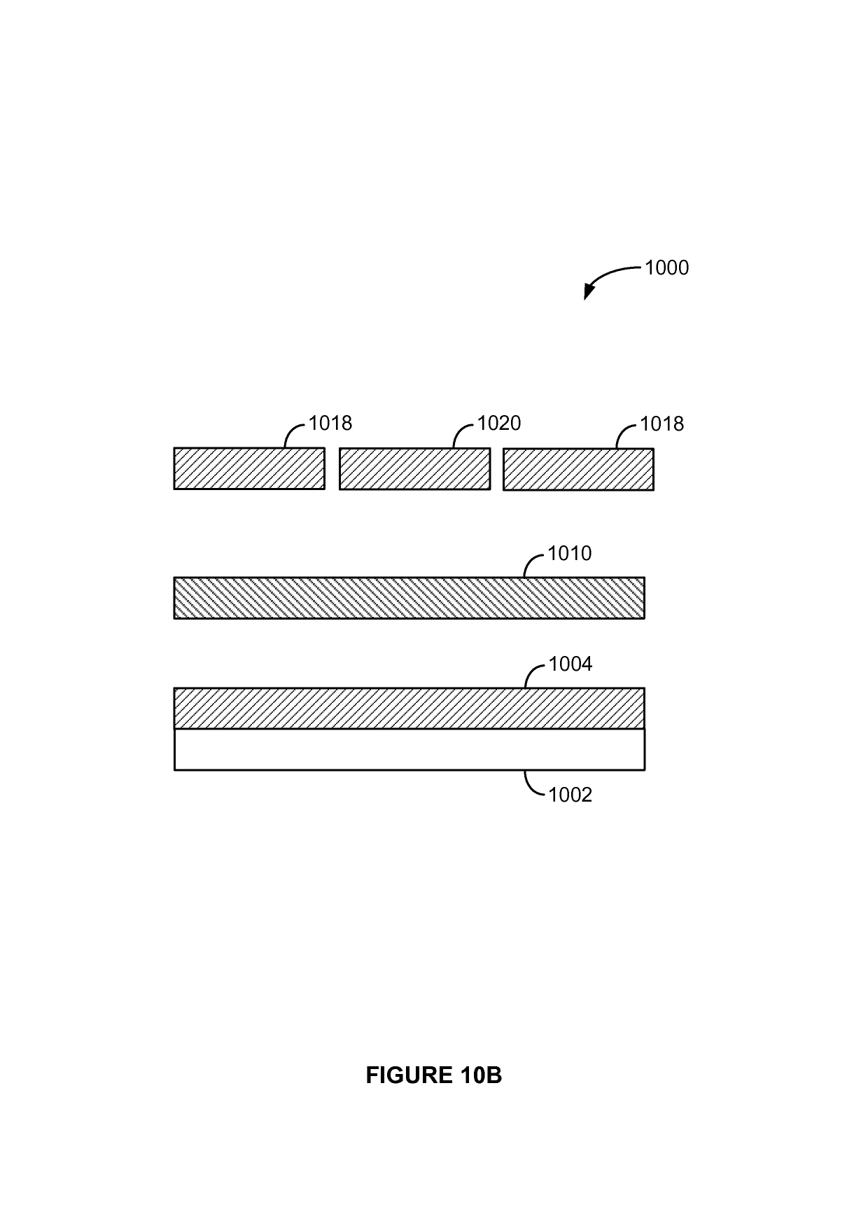

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning to remove portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

EMS devices also may be incorporated in various different electronic circuits. One type of EMS device is an EMS variable capacitance device or an EMS varactor. Two or more EMS varactors may be included in a variable capacitance assembly that may have a larger tuning capacitance range than a single EMS varactor. The variable capacitance assemblies described herein may include 3-metal layer, 4-terminal EMS varactors. A variable capacitance assembly including 2-metal layer, 2-terminal EMS varactors is described in U.S. patent application Ser. No. 12/642,421, titled “TWO-TERMINAL VARIABLE CAPACITANCE MEMS DEVICE,” filed Dec. 18, 2009, which is herein incorporated by reference.

In general, the variable capacitance assemblies described herein may be implemented in any circuits which employ frequency tuning and/or matching, such as tunable filters (e.g., band-pass filters, notch filters, etc.) and antenna matching networks. The variable capacitance assemblies described herein also may be implemented in high power handling devices, including RF filter circuits and antenna networks, for example.

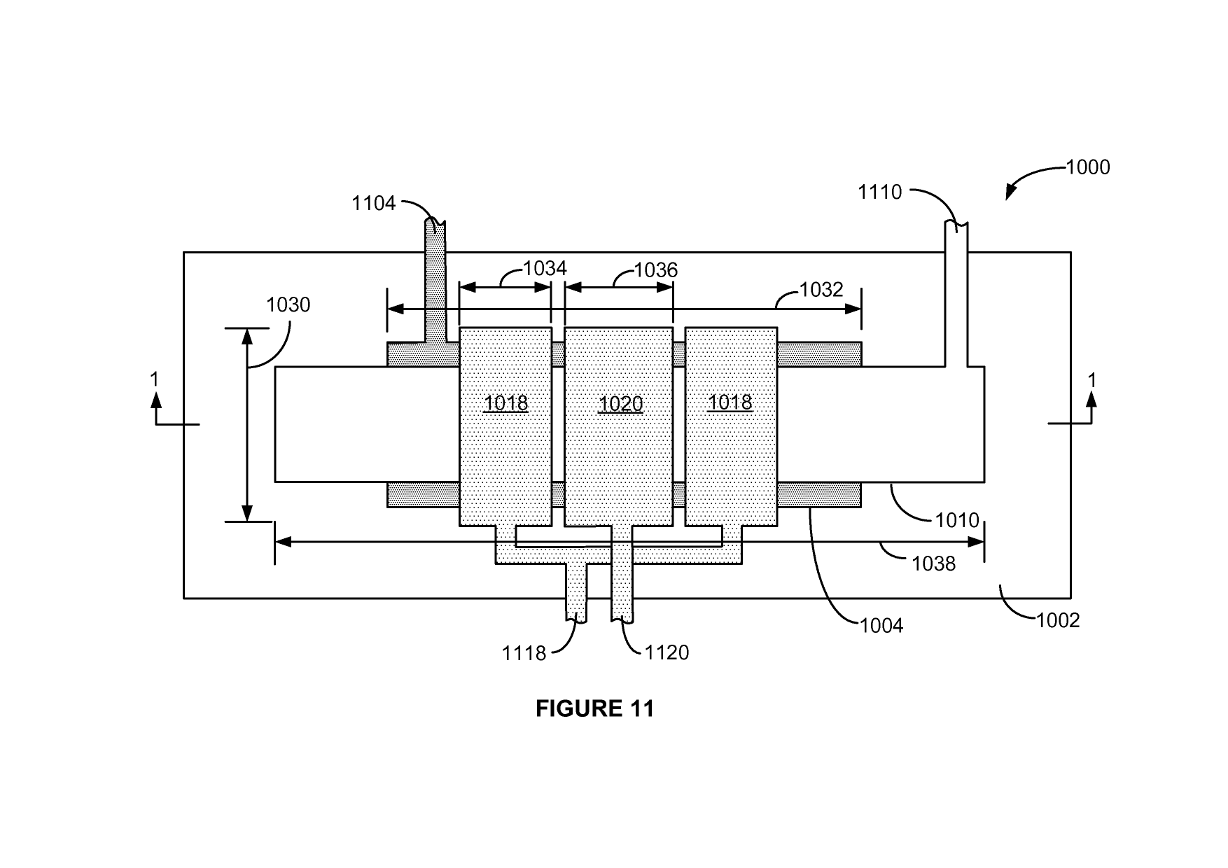

FIG. 9 shows an example of a cross-sectional schematic illustration of a variable capacitance assembly. The variable capacitance assembly 900 shown in FIG. 9 includes three EMS varactors 920, 940, and 960, which are all 3-metal layer, 4-terminal EMS varactors. A variable capacitance assembly may include fewer or more EMS varactors, however. For example, a variable capacitance assembly may include two or more than three EMS varactors.

As shown in FIG. 9, the EMS varactor 920 includes a first bias electrode 922 and a first RF electrode 924 that are spaced apart from one another and define a first air gap 930. Further, the EMS varactor 920 includes a metal layer above the first RF electrode 924, which forms second bias electrodes 928 and a second RF electrode 926. The first RF electrode 924 and the metal layer including the second bias electrodes 928 and the second RF electrode 926 define a second air gap 932. Similarly, the EMS varactors 940 and 960 include first bias electrodes 942 and 962, first RF electrodes 944 and 964, second bias electrodes 948 and 968, second RF electrodes 946 and 966, first air gaps 950 and 970, and second air gaps 952 and 972, respectively.

In some implementations, each of the EMS varactors 920, 940, and 960 may be similar to one another, including the sizes and materials of the first bias electrodes 922, 942, and 962, the first RF electrodes 924, 944, and 964, and the second RF electrodes 926, 946, and 966. The sizes of the first air gaps 930, 950, and 970 may be the same, and the sizes of the second air gaps 932, 952, and 972 also may be the same. A difference between the EMS varactors 920, 940, and 960 may be the sizes of the second bias electrodes 928, 948, and 968. As shown in FIG. 9, the second bias electrodes 928 are wider that the second bias electrodes 948, and the second bias electrodes 948 are wider than the second bias electrodes 968. Thus, the second bias electrodes 928, 948, and 968 of each the EMS varactors may have a different projected area perpendicular to a surface of the first RF electrodes 924, 944, and 964 and onto the surface of the first RF electrodes 924, 944, and 964, respectively.

The variable capacitance assembly 900 also includes four terminals 982, 984, 986, and 988. Each of the four terminals electrically connects components of each of the EMS varactors 920, 940, and 960. A first RF terminal 982 electrically connects the first RF electrodes 924, 944, and 964. A second RF terminal 984 electrically connects the second RF electrodes 926, 946, and 966. A first bias terminal 986 electrically connects the first bias electrodes 922, 942, and 962. A second bias terminal 988 electrically connects the second bias electrodes 928, 948, and 968. Thus, the terminals 982, 984, 986, and 988 connect the EMS varactors 920, 940, and 960 in parallel in the variable capacitance assembly 900.

The EMS varactors 920, 940, and 960 also may include dielectric layers (not shown) overlaying the first bias electrodes 922, 942, and 962 and overlaying the metal layer including the second RF electrodes 926, 946, and 966 and the second bias electrodes 928, 948, and 968. These dielectric layers may prevent contact between the first RF electrodes 924, 944, and 964 and the other electrodes in the EMS varactors 920, 940, and 960.

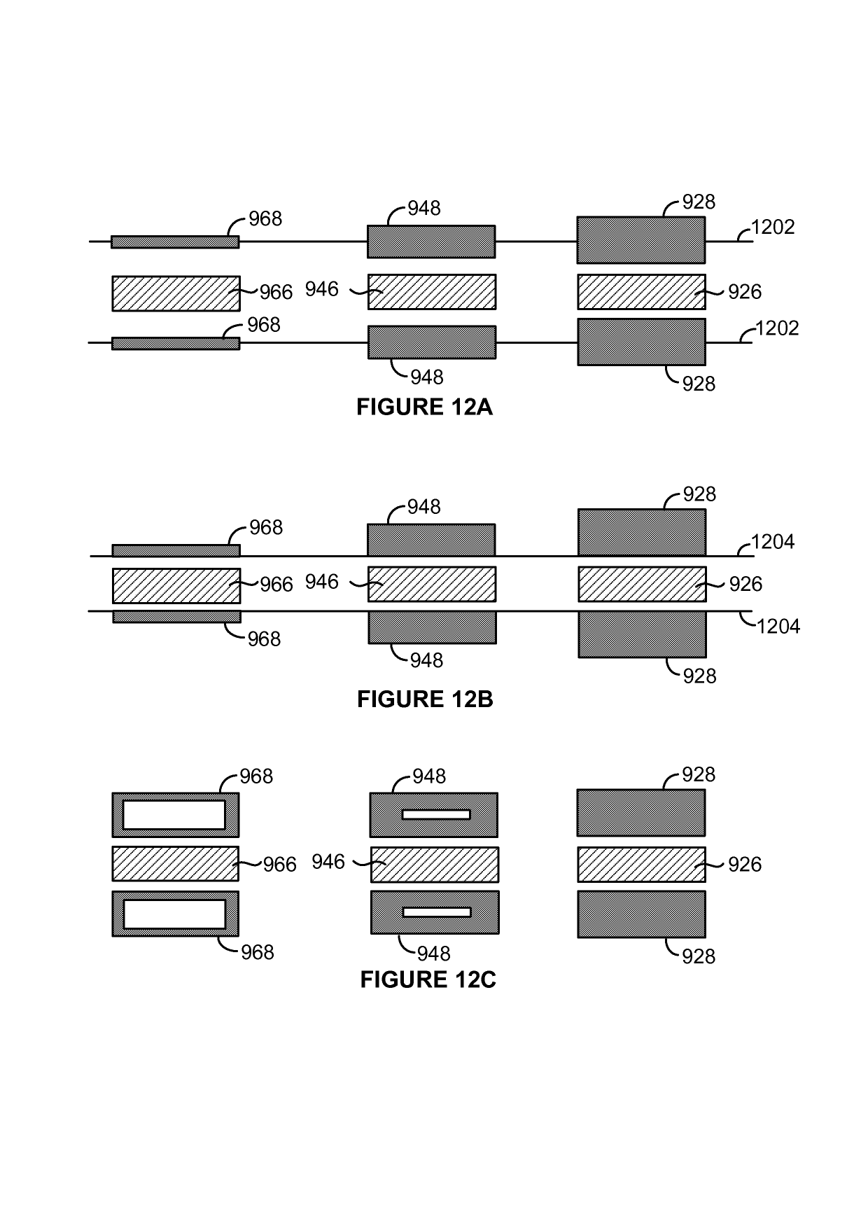

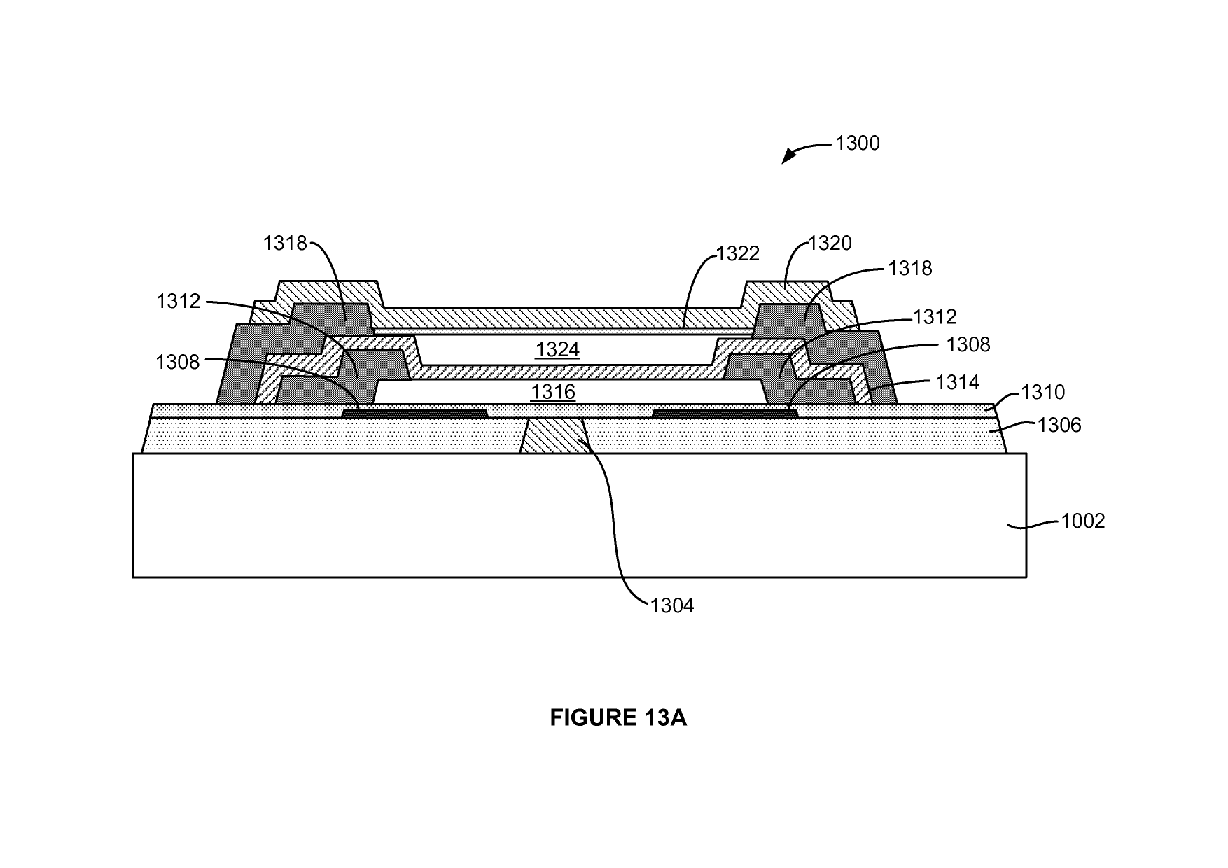

Different configurations of 3-metal layer, 4-terminal EMS varactors may be incorporated in a variable capacitance assembly. FIGS. 10A and 10B show examples of cross-sectional schematic illustrations of an EMS varactor that may be incorporated in a variable capacitance assembly. FIG. 11 shows an example of a top-down schematic illustration of the EMS varactor shown in FIGS. 10A and 10B. The cross-sectional schematic illustration of the EMS varactor shown in FIG. 10A is shown by the lines 1-1 in FIG. 11.

Turning first to FIG. 10A, the EMS varactor 1000 includes a substrate 1002 having a first bias electrode 1004 on the substrate 1002. A non-planarized first dielectric layer 1006 is on the substrate 1002 and on the first bias electrode 1004. First dielectric supports 1008 on the non-planarized first dielectric layer 1006 support a first RF electrode 1010. The non-planarized first dielectric layer 1006 and the first RF electrode 1010 define a first air gap 1012. In some implementations, the first air gap 1012 may be about 100 nanometers (nm) to 300 nm thick, or about 200 nm thick. Second dielectric supports 1014 on the first RF electrode 1010 support a non-planarized second dielectric layer 1016. The non-planarized second dielectric layer 1016 is over a metal layer including second bias electrodes 1018 and a second RF electrode 1020. A third dielectric layer 1024 may serve to insulate the second bias electrodes 1018 and the second RF electrode 1020. The first RF electrode 1010 and the third dielectric layer 1024 define a second air gap 1022. In some implementations, the second air gap 1022 may be about 100 nm to 300 nm thick, or about 200 nm thick.

The substrate 1002 may include different substrate materials, including transparent materials (e.g., glass, quartz, etc.), non-transparent materials (e.g., silicon (Si), gallium arsenide (GaAs), silicon carbide (SiC), indium phosphide (InP), galluium nitride (GaN), etc.), flexible materials (polyethylene terephthalate (PET), polyethylene naphthalate (PEN), a plastic, etc.), rigid materials, or combinations of these. In some implementations, the substrate 1002 has dimensions of hundreds of microns. In some implementations, the substrate 1002 may be hundreds of microns thick (e.g., about 100 microns to 700 microns thick for glass substrates).

The first bias electrode 1004, the first RF electrode 1010, the second bias electrodes 1018, and the second RF electrode 1020 may be made of any number of different metals, including aluminum (Al), copper (Cu), molybdenum (Mo), tantalum (Ta), chromium (Cr), neodymium (Nd), tungsten (W), titanium (Ti), and an alloy including at least one of these metals. For example, in some implementations, the electrodes may be made of a metal with a low film resistivity, such as Cu, Al, or Al doped with Si or Cu. In RF applications, a metal with a low film resistivity may reduce RF power losses in a high quality factor EMS varactor. In some implementations, all of the electrodes may be made of the same metal. For example, in some implementations, the second bias electrodes 1018 and the second RF electrode 1020 may be the same metal, and in some other implementations, the second bias electrodes 1018 and the second RF electrode 1020 may be made of different metals. In some implementations, for example, the second bias electrodes 1018 may be a metal with a higher resistivity than the metal of the second RF electrode 1020. For example, better EMS varactor performance may be attained when the RF electrodes have a low resistance (e.g., less than about 1 ohm), because it may result in lower energy dissipation by the EMS varactor. The bias electrodes of an EMS varactor may have a high resistance (e.g., greater than about 100 kilo-ohms), which may aid in preventing RF signal from propagating though the bias electrodes. RF signal propagating though the bias electrodes may be undesirable from a circuit perspective. RF signal propagating though the bias electrodes may cause RF signal and/or power loss, which may cause the EMS varactor to be lossy (i.e., the quality factor of the EMS varactor decreases) and lead to increased power consumption. The first bias electrode 1004 may be about 0.5 microns to 1 micron thick. The first RF electrode 1010 also may be about 0.5 microns to 1 micron thick. The second bias electrodes 1018 and the second RF electrode 1020 may be about 1 micron to 3 microns thick.

The dielectric material of the non-planarized first dielectric layer 1006, the first dielectric supports 1008, the second dielectric supports 1014, the non-planarized second dielectric layer 1016, and the third dielectric layer 1024 may be a number of different dielectric materials. In some implementations, the dielectric materials may include silicon dioxide (SiO₂), aluminum oxide (Al₂O₃), hafnium oxide (HfO₂), titanium oxide (TiO₂), silicon oxynitride (SiON), or silicon nitride (SiN).

In some implementations, the non-planarized first dielectric layer 1006 may be a SiO₂ layer. The non-planarized first dielectric layer 1006 may have a thickness of less than about 200 nm for low voltage implementations of the EMS varactor 1000 (i.e., implementations in which a low DC voltage is applied to the EMS varactor 1000 for varactor operation). A low DC voltage may be about 1.5 volts to 3.5 volts or about 5 volts to 20 volts. For high voltage implementations of the EMS varactor 1000 (i.e., implementations in which a high DC voltage is applied to the EMS varactor 1000 for varactor operation), the non-planarized first dielectric layer 1006 may be thicker than about 200 nm. A high DC voltage may be greater than about 20 volts or greater than about 30 volts.

In some implementations, the first dielectric supports 1008 and the second dielectric supports 1014 may be SiO₂ or SiON. In some implementations, the dielectric supports 1008 and 1014 may not form a planar layer of material. A dielectric support may have a thickness of about 0.5 microns to 2 microns in different regions of the dielectric support.

In some implementations, the non-planarized second dielectric layer 1016 may be about 3 microns to 7 microns thick, or about 5 microns thick. In some implementations, the non-planarized second dielectric layer 1016 may be thick enough such that it does not mechanically move into the second air gap 1022 during operation of the EMS varactor 1000. In some implementations, the non-planarized second dielectric layer 1016 may include a number of different dielectric layers (e.g., 5 to 6) stacked on one another. In some implementations, the non-planarized second dielectric layer 1016 may form an encapsulation shell for the EMS varactor 1000. An encapsulation shell may protect the EMS varactor 1000 from the atmosphere or the environment. In some implementations, the third dielectric layer 1024 may be about 100 nm to 300 nm thick.

FIG. 10B shows a simplified cross-sectional schematic illustration of the EMS varactor 1000, depicting the electrodes and excluding the dielectric layers and the dielectric supports. The EMS varactor 1000 shown in FIG. 10B includes the substrate 1002, the first bias electrode 1004, the first RF electrode 1010, the second bias electrodes 1018, and the second RF electrode 1020, as described above.

In the top-down view of the EMS varactor 1000 shown in FIG. 11, the substrate 1002 and the electrodes of the EMS varactor 1000 are shown. The dielectric layers are not shown for clarity. As shown in FIG. 11, terminal 1104 is a lead to the first bias electrode 1004, terminal 1110 is a lead to the to the first RF electrode 1010, terminal 1118 is a lead to the second bias electrodes 1018, and terminal 1120 is a lead to the second RF electrode 1020. As shown, the EMS varactor 1000 is a 3-metal layer, 4-terminal varactor.

The configuration of the terminals shown in FIG. 11 is an example of one configuration of the terminals, and other terminal configurations are possible. For example, the terminals may lead to different sides or regions of the electrodes. Further, while the first bias electrode 1004, the first RF electrode 1010, the second bias electrodes 1018, and the second RF electrode 1020 are shown as having a rectangular shape in FIG. 11, other electrode shapes are possible. For example, the electrodes may have a circular shape or a square shape.

In some implementations, a dimension 1030 of the electrodes 1004, 1010, 1018, and 1020 may be about 20 microns to 80 microns. In some implementations, a dimension 1034 of a second bias electrode 1018 may be about 20 microns to 40 microns, or about 30 microns, and a dimension 1036 of the second RF electrode 1020 may be about 20 microns to 40 microns, or about 30 microns. A dimension 1032 of the first bias electrode 1004 may be about 100 microns to 200 microns, about 150 microns, or about 170 microns, in some implementations. A dimension 1038 of the first RF electrode 1010 may be about 100 microns to 200 microns, about 150 microns, or about 170 microns, in some implementations. The dimensions 1030, 1032, 1034, 1036, and 1038 are example dimensions of one implementation of an EMS varactor. The dimensions may be scaled up or down, depending on the expected operation conditions of the EMS varactor.

Further details regarding the individual EMS varactor shown in FIGS. 10A, 10B, and 11, are discussed in U.S. patent application Ser. No. 13/279,074, titled “ELECTROMECHANICAL SYSTEMS VARIABLE CAPACITANCE DEVICE,” filed Oct. 21, 2011, which is herein incorporated by reference.

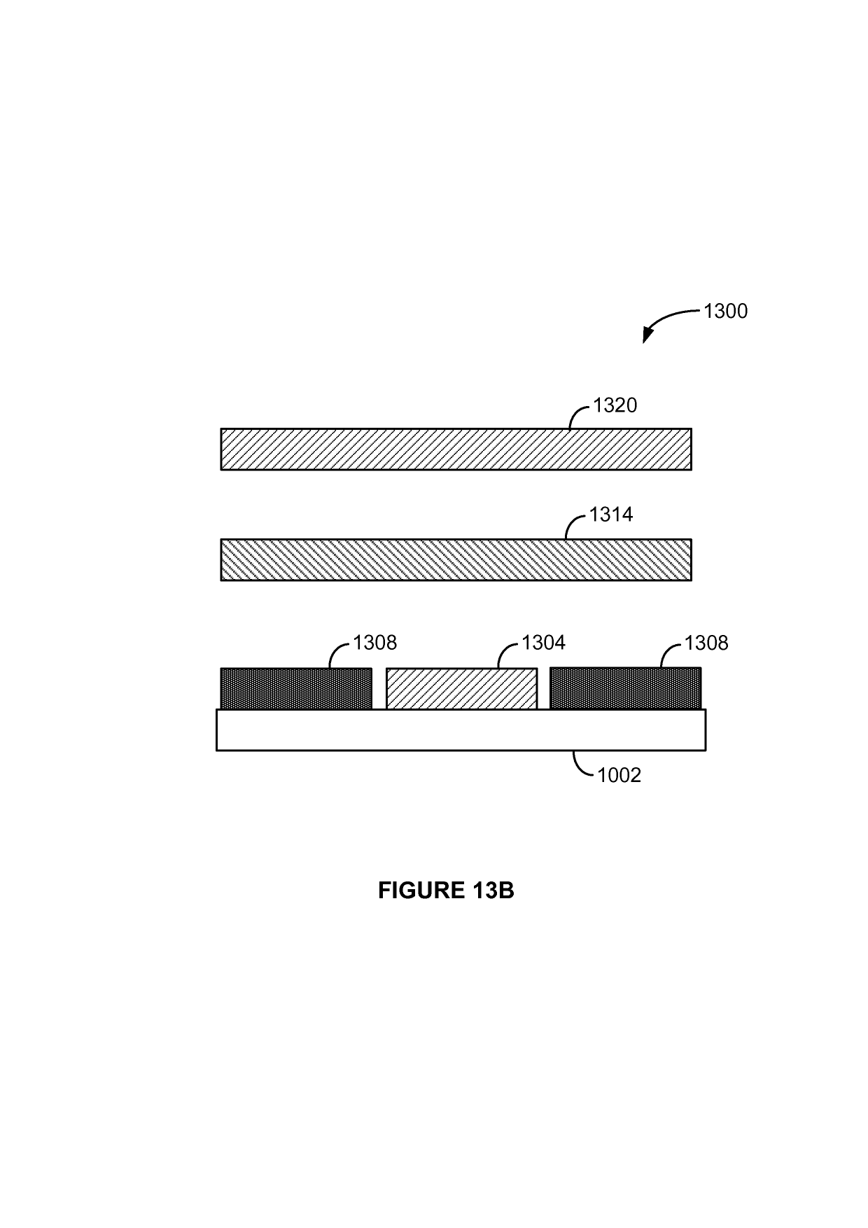

FIGS. 12A-12C show examples of top-down schematic illustrations of second RF electrodes and second bias electrodes of EMS varactors in a variable capacitance assembly. Each of FIGS. 12A-12C shows a set of second RF electrodes and second bias electrodes that might be used in the EMS varactors 920, 940, and 960 of the variable capacitance assembly 900 shown in FIG. 9. For example, as shown in FIG. 12A, the second bias electrodes 928, 948, and 968 on either side of the second RF electrodes 926, 946, and 966 share an axis of symmetry 1202. The different configurations of second RF electrodes and second bias electrodes shown in FIGS. 12A-12C are design options with trade-offs among the following factors: (i) capacitance tuning range control of an EMS varactor due to the effective electrostatic force and the mechanical bending/displacement of the first RF electrode; (ii) bias voltage control range; and (iii) variable capacitance assembly device size (e.g., compact device designs may be used to reduce the chip size).

As shown in FIG. 12B, the second bias electrodes 928, 948, and 968 on either side of the second RF electrodes 926, 946, and 966 have an edge aligned along a line 1204 spaced apart from the second RF electrodes 926, 946, and 966. A configuration of the second bias electrodes 928, 948, and 968 having an edge aligned a distance apart from the second RF electrodes may use lower bias voltages in the operation of a variable capacitance assembly. Further, a smaller variable capacitance assembly may be obtained using the second bias electrode configuration shown in FIG. 12B.

As shown in FIG. 12C, the second bias electrodes 928, 948, and 968 on either side of the second RF electrodes 926, 946, and 966 have the same outline but have different areas removed from a central portion of each of the second bias electrodes 948 and 968. A configuration of the second bias electrodes 928, 948, and 968 as shown in FIG. 12C may improve the linear bias voltage control of the EMS varactors in the variable capacitance assembly.

Further, the projected areas of the second bias electrodes 928, 948, and 968 perpendicular to a surface of the first RF electrode 924, 944, and 964 (not shown) and onto the surface of the first RF electrode 924, 944, and 964, respectively, are different in FIGS. 12A-12C. In the top-down view shown in FIGS. 12A-12C, the first RF electrode 924, 944, and 964 would be in a plane parallel to and underneath a plane containing the second bias electrodes 928, 948, and 968 and the second RF electrodes 926, 946, and 966. For example, the projected area of the second bias electrodes 928 is greater than the projected area of the second bias electrodes 948. The projected area of the second bias electrodes 948 is greater than the projected area of the second bias electrodes 968.

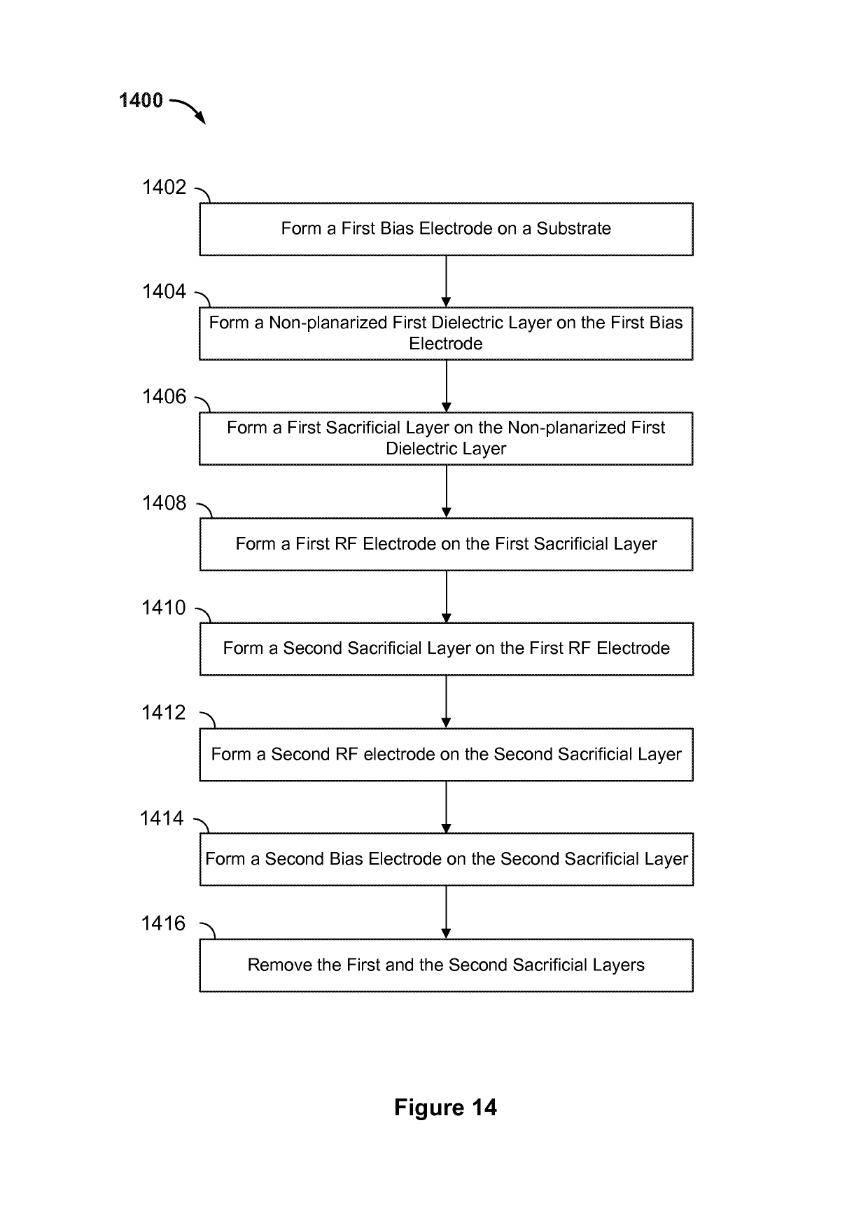

FIGS. 13A and 13B show examples of cross-sectional schematic illustrations of an EMS varactor that may be incorporated in a variable capacitance assembly. The EMS varactor shown in FIGS. 13A and 13B may be similar to the EMS varactor 1000 shown in FIGS. 10A, 10B, and 11, with one difference being that the EMS varactor 1000 has the first bias electrode 1004 deposited closer to the substrate 1002 than the second bias electrodes 1018 and the second RF electrode 1020, whereas the EMS varactor shown in FIGS. 13A and 13B has first bias electrodes 1308 and a first RF electrode 1304 deposited closer to a substrate 1002 than a second bias electrode 1320.

In some implementations, the EMS varactor 1000 shown in FIGS. 10A, 10B, and 11 and an EMS varactor 1300 shown in FIG. 13A and 13B may have similar performance characteristics.

Turning first to FIG. 13A, the EMS varactor 1300 includes the substrate 1002 having the first RF electrode 1304 on the substrate 1002. A first dielectric layer 1306 is on the substrate 1002 and adjacent to the first RF electrode 1304. The first bias electrodes 1308 are on the first dielectric layer 1306 and are covered by a second dielectric layer 1310. The second dielectric layer 1310 also is on the first dielectric layer 1306. First dielectric supports 1312 on the second dielectric layer 1310 support a second RF electrode 1314. The second dielectric layer 1310 and the second RF electrode 1314 define a first air gap 1316. In some implementations, the first air gap 1316 may be about 100 nm to 300 nm thick, or about 200 nm thick. Second dielectric supports 1318 on the second RF electrode 1314 support the second bias electrode 1320. A third dielectric layer 1322 may serve to insulate the second bias electrode 1320. The second RF electrode 1314 and the third dielectric layer 1322 define a second air gap 1324. In some implementations, the second air gap 1324 may be about 100 nm to 300 nm thick, or about 200 nm thick.

The substrate 1002 may include different substrate materials, including transparent materials, non-transparent materials, flexible materials, rigid materials, or combinations of these. Some examples of the substrate 1002 include glass, silicon, etc. In some implementations, the substrate 1002 has dimensions of hundreds of microns. In some implementations, the substrate 1002 may be hundreds of microns thick (e.g., about 100 microns to 700 microns thick for glass substrates).

The first RF electrode 1304, the first bias electrodes 1308, the second RF electrode 1314, and the second bias electrode 1320 may be made of any number of different metals, including Al, Cu, Mo, Ta, Cr, Nd, W, Ti, and an alloy including at least one of these metals. For example, in some implementations, the electrodes may be made of Al or Al doped with Si or Cu. In some implementations, all of the electrodes may be made of the same metal. For example, in some implementations, the first bias electrodes 1308 and the first RF electrode 1304 may be the same metal, and in some other implementations, the first bias electrodes 1308 and the first RF electrode 1304 may be made of different metals. In some implementations, for example, the first bias electrodes 1308 may be a metal with a higher resistivity than the metal of the first RF electrode 1304. For example, good EMS varactor performance may be attained when the RF electrodes 1304 and 1314 have a low resistance (e.g., less than about 1 ohm), which may result in a low energy dissipation by the EMS varactor. The bias electrodes 1308 and 1320 of an EMS varactor may have a high resistance (e.g., greater than about 100 kilo-ohms), which may aid in preventing RF signal from propagating though the bias electrodes 1308 and 1320. RF signal propagating though the bias electrodes may be undesirable from a circuit perspective. RF signal propagating though the bias electrodes may cause RF signal and/or power loss, which may cause the EMS varactor to be lossy (i.e., the quality factor of the EMS varactor decreases) and lead to increased power consumption. The first RF electrode 1304 may be about 1 micron to 3 microns thick. The first bias electrodes 1308 may be about 0.5 microns to 1 micron thick. The second RF electrode 1314 also may be about 0.5 microns to 1 micron thick. The second bias electrode 1320 may be about 1 micron to 3 microns thick.

The dielectric layers 1306, 1310, and 1322 may be a number of different dielectric materials. In some implementations, the dielectric materials may include SiO₂, Al₂O₃, HfO₂, TiO₂, SiON, or SiN. In some implementations, the dielectric material of the dielectric layer 1306 may include a planarization interlayer dielectric such as benzocyclobutene (BCB), polyimide, acrylic, spin-on-glass (SOG), etc. The dielectric layers 1306, 1310, and 1322 may each be about 100 nm to 2 microns thick.

In some implementations, the first dielectric supports 1312 and the second dielectric supports 1318 may be SiO₂ or SiON. In some implementations, the dielectric supports 1312 and 1318 may not form a planar layer of material. Each of the dielectric supports 1312 and 1318 may have a thickness of about 0.5 microns to 2 microns in different regions of the respective dielectric support.

FIG. 13B shows a simplified cross-sectional schematic illustration of the EMS varactor 1300, depicting the electrodes and excluding the dielectric layers 1306, 1310, and 1322 and the dielectric supports 1312 and 1318. The EMS varactor 1300 shown in FIG. 13B includes the substrate 1002, the first RF electrode 1304, the first bias electrodes 1308, the second RF electrode 1314, and the second bias electrode 1320, as described above.

While a top-down view of the EMS varactor 1300 is not shown, in some implementations, the dimensions of the electrodes in the EMS varactor 1300 may be similar to the dimensions described above with reference to the EMS varactor 1000 in FIG. 11. In some implementations, the dimensions of the electrodes in the EMS varactor 1300 may be scaled up or down, depending on the expected operation conditions of the EMS varactor.

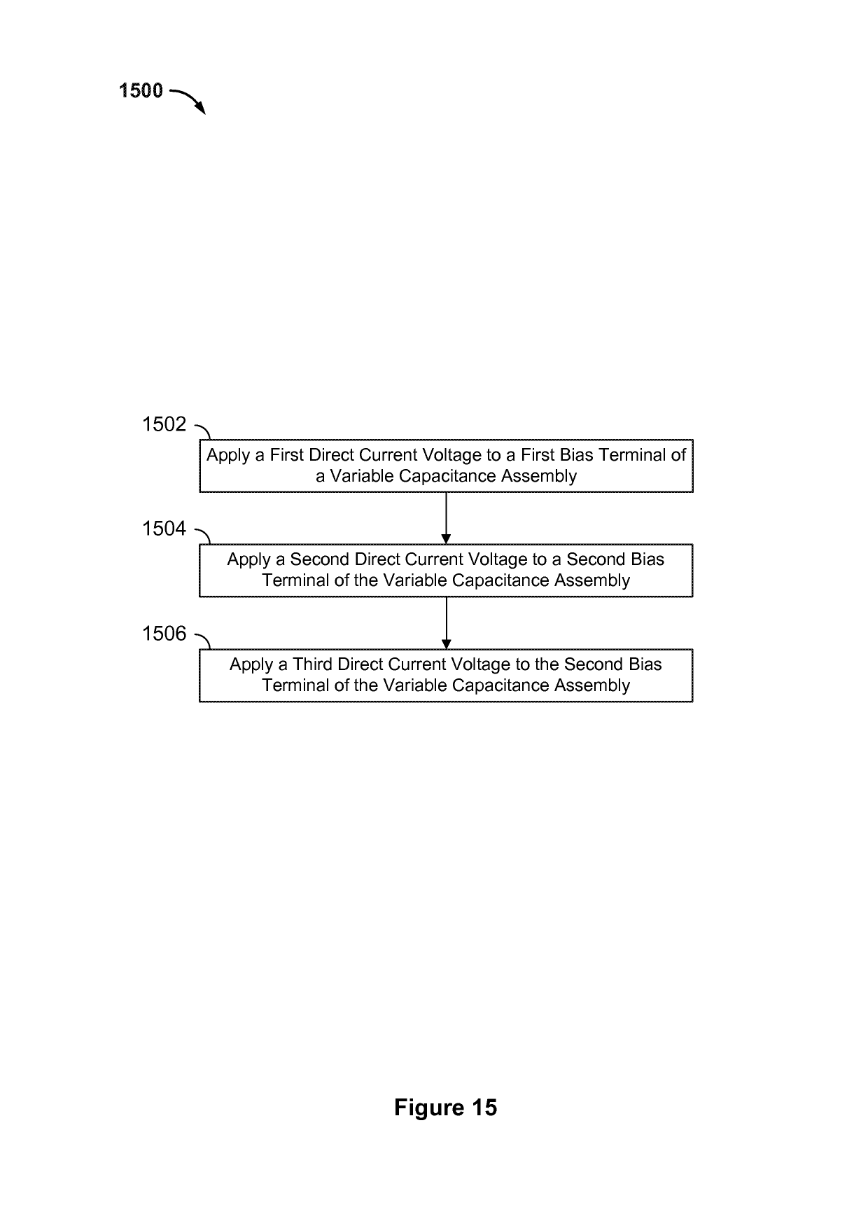

FIG. 14 shows an example of a flow diagram illustrating a manufacturing process for a variable capacitance assembly including an EMS varactor. More specifically, FIG. 14 shows an example of a flow diagram illustrating a manufacturing process for a variable capacitance assembly including a plurality of the EMS varactors 1000 shown in FIGS. 10A, 10B, and 11. Note that the operations of the process 1400 may be combined, rearranged, and or modified to form any of the variable capacitance assemblies including EMS varactors disclosed herein. Planarization processes also may be used in the manufacturing process for some EMS varactors. In the process 1400, patterning techniques, including masking as well as etching processes, may be used to define the shapes of the different components of an EMS varactor during the manufacturing process. Any number of EMS varactors of a plurality of EMS may be manufactured simultaneously with the process 1400.

Starting at block 1402 of the process 1400, a first bias electrode is formed on a substrate for one of a plurality of EMS varactors. The substrate may include different substrate materials, including transparent materials, non-transparent materials, flexible materials, rigid materials, or combinations of these. The first bias electrode may be a metal, including Al, Cu, Mo, Ta, Cr, Nd, W, Ti, or an alloy including at least one of these metals. The first bias electrode may be formed using deposition processes including PVD processes, CVD processes, and atomic layer deposition (ALD) processes.

At block 1404, a non-planarized first dielectric layer is formed on the first bias electrode for the one of the plurality of EMS varactors. The non-planarized first dielectric layer may include SiO₂, Al₂O₃, HfO₂, TiO₂, SiON, or SiN. The non-planarized first dielectric layer may be formed using deposition processes including PVD processes, CVD processes, including PECVD processes, and ALD processes. In some other implementations, the first dielectric layer may be planarized in a later process operation. For example, the first dielectric layer may be planarized using a spin-coating technique or a chemical mechanical polishing technique.

At block 1406, a first sacrificial layer is formed on the non-planarized first dielectric layer without planarizing the first dielectric layer for the one of the plurality of EMS varactors. The first sacrificial layer may include a XeF₂-etchable material such as Mo or amorphous Si in a thickness and size selected to provide, after subsequent removal, a gap having a desired thickness and size. The first sacrificial layer may be formed using deposition processes including PVD processes and CVD processes, including PECVD processes.

At block 1408, a first RF electrode is formed on the first sacrificial layer for the one of the plurality of EMS varactors. The first RF electrode may be a metal, including Al, Cu, Mo, Ta, Cr, Nd, W, Ti, or an alloy including at least one of these metals. The first RF electrode may be formed using deposition processes including PVD processes, CVD processes, and ALD processes.

At block 1410, a second sacrificial layer is formed on the first RF electrode for the one of the plurality of EMS varactors. The second sacrificial layer may include a XeF₂-etchable material such as Mo or amorphous Si in a thickness and size selected to provide, after subsequent removal, a gap having a desired thickness and size. The second sacrificial layer may be formed using deposition processes including PVD processes and CVD processes, including PECVD processes.

At block 1412, a second RF electrode is formed on the second sacrificial layer for the one of the plurality of EMS varactors. The second RF electrode may be a metal, including Al, Cu, Mo, Ta, Cr, Nd, W, Ti, or an alloy including at least one of these metals. The second RF electrode may be formed using deposition processes including PVD processes, CVD processes, and ALD processes.

At block 1414, a second bias electrode is formed on the second sacrificial layer for the one of the plurality of EMS varactors. The second bias electrode may be a metal, including Al, Cu, Mo, Ta, Cr, Nd, W, Ti, or an alloy including at least one of these metals. The second bias electrode may be formed using deposition processes including PVD processes, CVD processes, and ALD processes. The second bias electrode of each of the plurality of electromechanical systems varactors may have a different projected area perpendicular to a surface of the first radio frequency electrode, and onto the surface of the first radio frequency electrode.

In some implementations, the regions of the partially fabricated one of the plurality of EMS varactors that are to include the second RF electrode and the second bias electrode may be defined by a photoresist or other mask material prior to deposition of the electrodes. In some other implementations, such as when the second RF electrode and the second bias electrode are made of the same metals, a metal layer may be formed on the second sacrificial layer. In these other implementations, the metal layer may be patterned with photoresists after it is formed. The metal layer may then be etched to remove portions the metal layer from the surface of the sacrificial layer to form the second RF electrode and the second bias electrode.

At block 1416, the first and the second sacrificial layers are removed for the one of the plurality of EMS varactors. When the first and the second sacrificial layers are Mo or amorphous Si, XeF₂ may be used to remove the sacrificial layers by exposing the sacrificial layers to XeF₂.

In some implementations, a non-planarized second dielectric layer may be formed on the second bias electrode and the second RF electrode for the one of the plurality of EMS varactors. The non-planarized second dielectric layer may include dielectric materials, such as SiO₂, Al₂O₃, HfO₂, TiO₂, SiON, SiN, or layers of these dielectrics. The non-planarized second dielectric layer may be formed using deposition processes including PVD processes and CVD processes, including PECVD processes.

In some implementations, a dielectric layer may be formed on the first bias electrode and a dielectric layer may be formed on the second sacrificial layer (e.g., on which the second bias electrode and the second RF electrode may be formed) for the one of the plurality of EMS varactors to fabricate the EMS varactor 1000 shown in FIG. 10A.

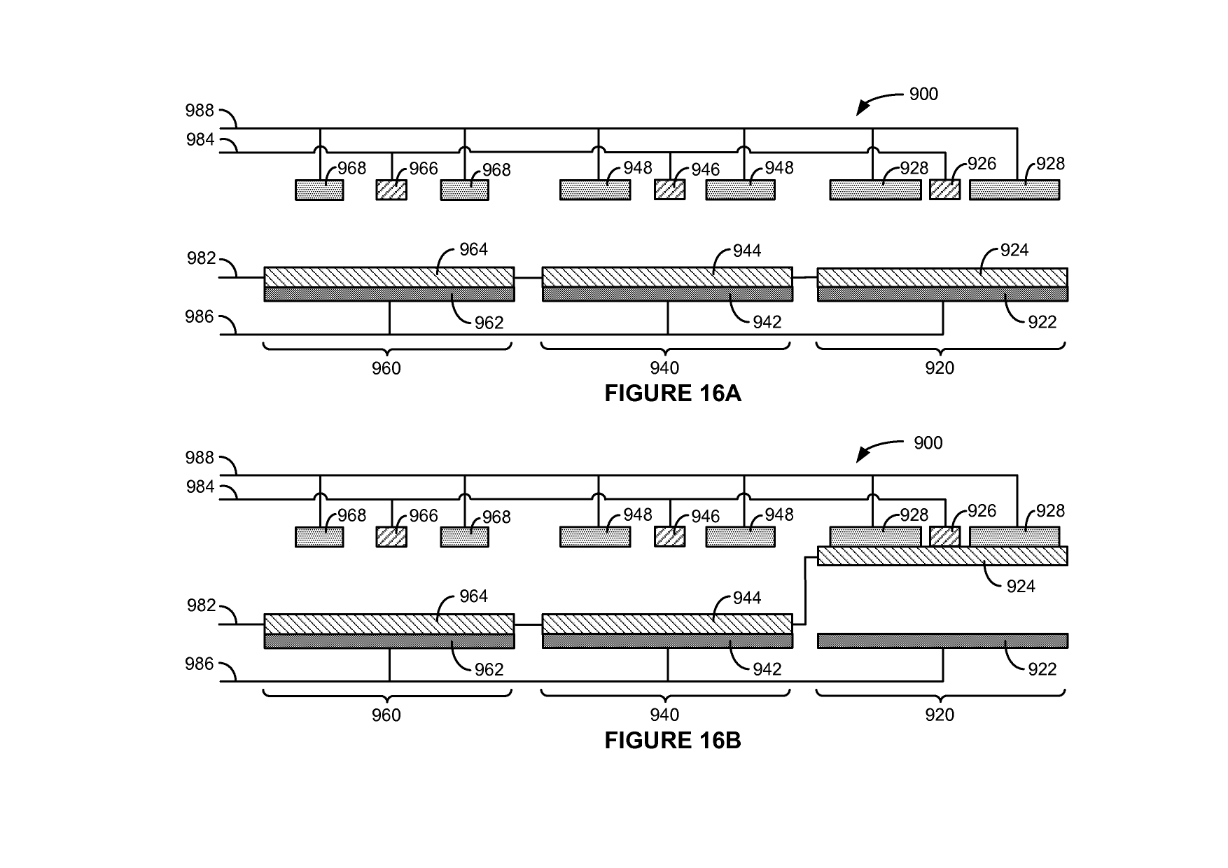

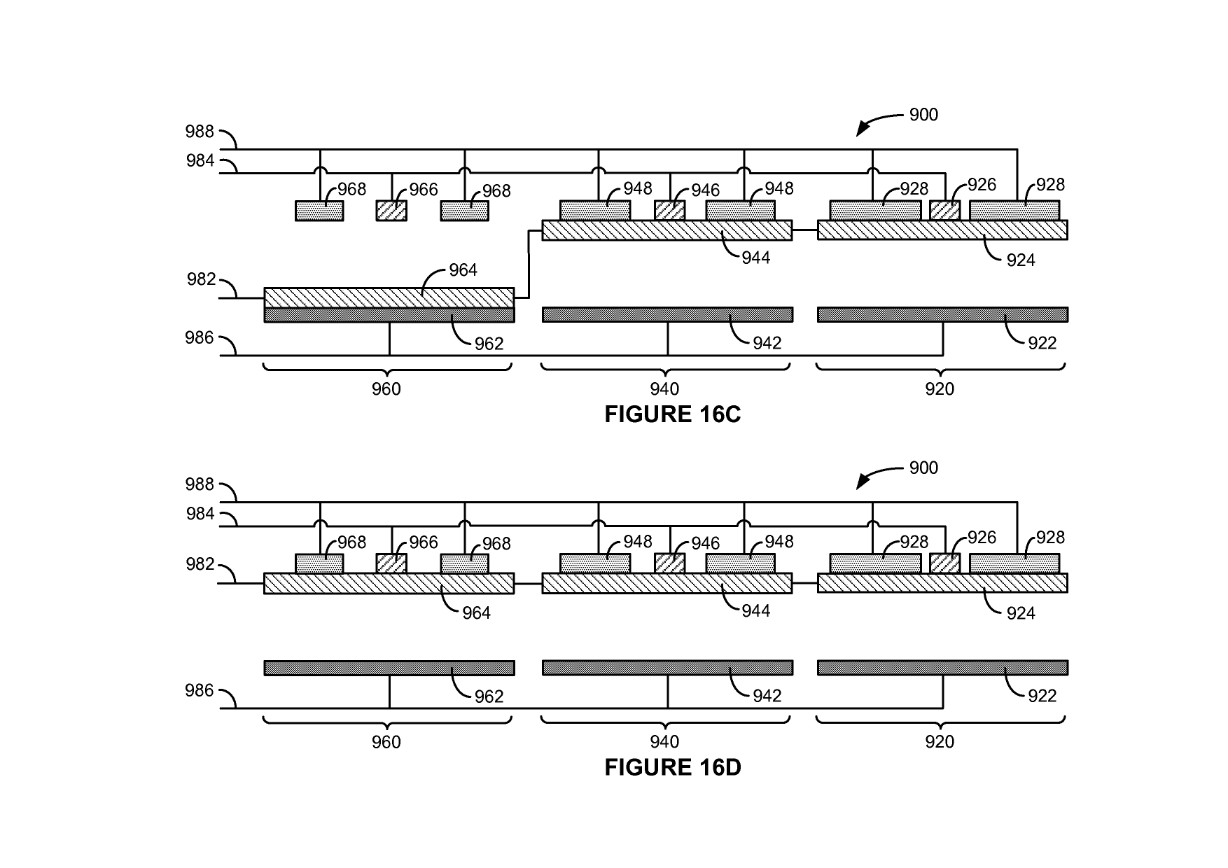

FIG. 15 shows an example of a flow diagram illustrating a method of operation of a variable capacitance assembly. FIGS. 16A-16D show examples of the variable capacitance assembly at various stages in the method of operation. The variable capacitance assembly shown in FIGS. 16A-16D is the variable capacitance assembly 900 described with respect to FIG. 9.

Turning to FIG. 15, at block 1502 of the method 1500, a first DC voltage is applied to the first bias terminal 986 of the variable capacitance assembly 900. The first DC voltage may cause the first RF electrodes 924, 944, and 964 of each of the EMS varactors 920, 940, and 960, respectively, to mechanically move to a first state. In the first state, the first RF electrodes 924, 944, and 964 may be in contact with a dielectric layer (not shown) overlaying the first bias electrodes 922, 942, and 962. FIG. 16A shows an example of the variable capacitance assembly 900 at this point (i.e., up through block 1502) in the method 1500. As shown in FIG. 16A, the first RF electrodes 924, 944, and 964 are all in a first state.

At block 1504, a second DC voltage is applied to the second bias terminal 988 of the variable capacitance assembly 900 after applying the first DC voltage to the first bias terminal 986. The second DC voltage may cause the first RF electrode 924 of the EMS varactor 920 to mechanically move from the first state to a second state. In the second state, the first RF electrode 924 may be in contact with a dielectric layer (not shown) overlaying the second bias electrodes 928 and the second RF electrode 926. FIG. 16B shows an example of the variable capacitance assembly 900 at this point (i.e., up through block 1504) in the method 1500. As shown in FIG. 16B, the first RF electrodes 944 and 964 of the EMS varactors 940 and 960 are in the first state and the first RF electrode 924 of the EMS varactor 920 is in the second state.

At block 1506, a third DC voltage is applied to the second bias terminal 988 of the variable capacitance assembly 900 after applying the first DC voltage to the first bias terminal 986. The third DC voltage may cause the first RF electrodes 924 and 944 of the EMS varactors 920 and 940 to mechanically move from the first state to the second state. In the second state, the first RF electrodes 924 and 944 may be in contact with a dielectric layer (not shown) overlaying the second bias electrodes 928 and 948 and the second RF electrodes 926 and 946. FIG. 16C shows an example of the variable capacitance assembly 900 at this point (i.e., up through block 1506) in the method 1500. As shown in FIG. 16C, the first RF electrode 964 of the EMS varactor 960 is in the first state and the first RF electrodes 924 and 944 of the EMS varactors 920 and 940 are in the second state.

In some implementations, the third DC voltage may be greater than the second DC voltage. The second DC voltage may be large enough to mechanically move the first RF electrode 924 from the first state to the second state but not large enough to mechanically move the first RF electrodes 944 and 964 from the first state to the second state.

A force between the first RF electrodes 924, 944, and 964 and the second bias electrodes 928, 948, and 968 generated by a DC voltage applied to the second bias terminal 988 may be proportional, based on Coulomb's inverse-square law, to the areas of the second bias electrodes 928, 948, and 968. Thus, the force generated by the second DC voltage may be large enough, due the large area of the second bias electrodes 928, to mechanically move the first RF electrode 924 from the first state to the second state but not large enough to mechanically move the first RF electrodes 944 and 964 from the first state to the second state. Similarly, the force generated by the third DC voltage may be large enough to mechanically move the first RF electrodes 924 and 944 from the first state to the second state but not large enough to mechanically move the first RF electrode 964 from the first state to the second state.

Operation of the variable capacitance assembly 900 may continue with the application of a fourth DC voltage to the second bias terminal 988 of the variable capacitance assembly 900 after applying the first DC voltage to the first bias terminal 986. The fourth DC voltage may cause the first RF electrodes 924, 944, and 964 of the EMS varactors 920, 940, and 960 to mechanically move from the first state to the second state. In the second state, the first RF electrodes 924, 944, and 964 may be in contact with a dielectric layer (not shown) overlaying the second bias electrodes 928, 948, and 968 and the second RF electrode 926, 946, and 966. FIG. 16D shows an example of the variable capacitance assembly 900 at this point. As shown in FIG. 16D, the first RF electrodes 924, 944, and 964 are in the second state.

In some implementations, the fourth DC voltage may be greater than both the second DC voltage and the third DC voltage. The fourth DC voltage may be large enough to mechanically move the first RF electrodes 924, 944, and 964 from the first state to the second state, as explained above.

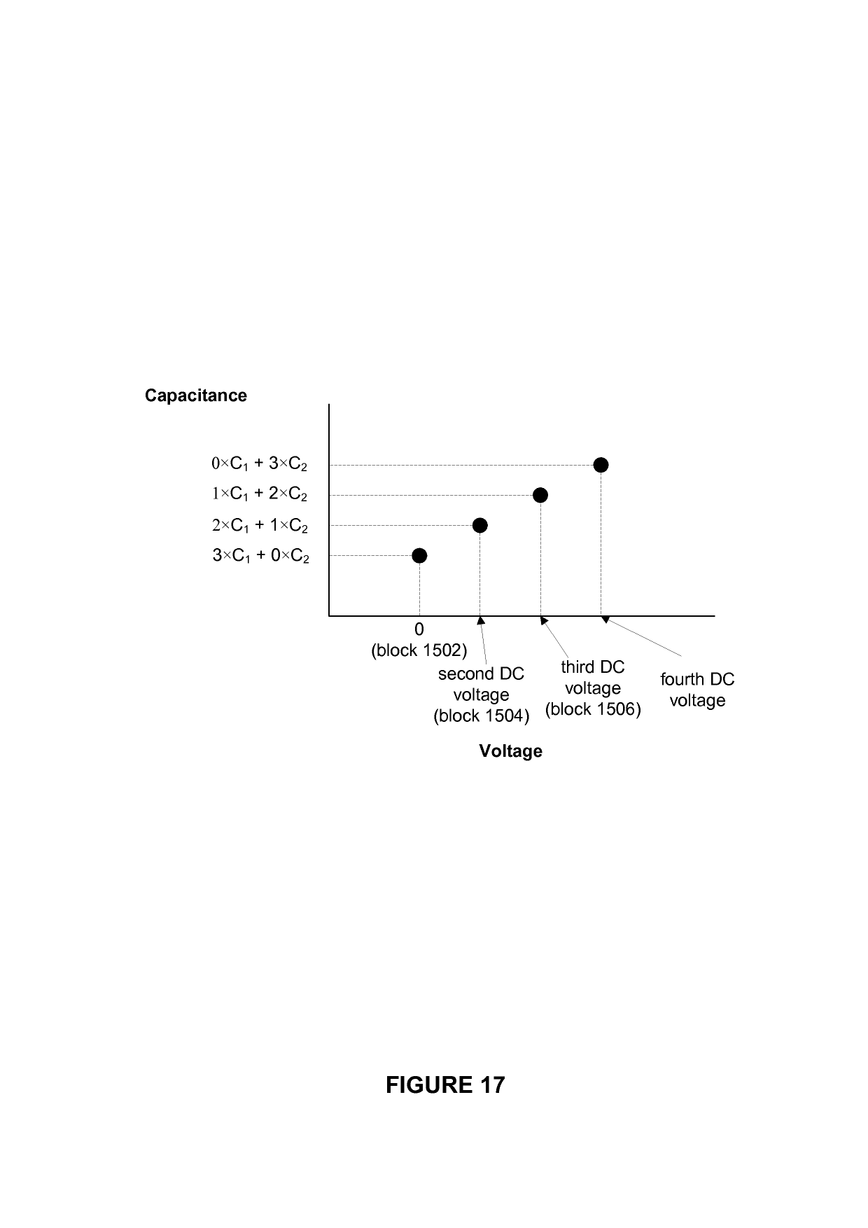

FIG. 17 shows an example of a graph showing the capacitance of a variable capacitance assembly versus the DC voltage applied to the second bias terminal of the variable capacitance assembly. The graph of capacitance shown in FIG. 17 corresponds to the variable capacitance assembly 900 in the different configurations described above with respect to FIGS. 16A-16D and in part to the method 1500 described above with respect to FIG. 15. When the EMS varactors 920, 940, and 960 of the variable capacitance assembly 900 are similar (e.g., similar electrical properties and dimensions of the first RF electrodes and the second RF electrodes and similar dimensions of the air gaps), the capacitance of each of the EMS varactors 920, 940, and 960 when in a first state or in a second state may be similar. For example, in the first state, each of the EMS varactors 920, 940, and 960 may have a capacitance C₁, and in the second state, each of the EMS varactors 920, 940, and 960 may have a capacitance C₂.

At block 1502, after a first DC voltage is applied to the variable capacitance assembly 900 and the first RF electrodes 924, 944, and 964 are in a first state, the capacitance of the variable capacitance assembly 900 between the first RF terminal 982 and the second RF terminal 984 may be 3×C₁+0×C₂. At block 1504, after the first DC voltage and a second DC voltage are applied to the variable capacitance assembly 900, the EMS varactor 920 is in a second state and the EMS varactors 940 and 960 are in a first state. The capacitance of the variable capacitance assembly 900 between the first RF terminal 982 and the second RF terminal 984 at block 1504 may be 2×C₁+1×C₂. At block 1506, after the first DC voltage and a third DC voltage are applied to the variable capacitance assembly 900, with the third DC voltage being greater than the second DC voltage, the EMS varactors 920 and 940 are in the second state and the EMS varactor 960 is in the first state. The capacitance of the variable capacitance assembly 900 between the first RF terminal 982 and the second RF terminal 984 at block 1506 may be 1×C₁+2×C₂. After the first DC voltage and a forth DC voltage are applied to the variable capacitance assembly 900, with the fourth DC voltage being greater than the second and third DC voltages, the EMS varactors 920, 940, and 960 are in the second state. The capacitance of the variable capacitance assembly 900 between the first RF terminal 982 and the second RF terminal 984 may be 0×C₁+3×C₂.

While FIGS. 15, 16A-16D, and 17 show the first DC voltage being applied, the second DC voltage being applied, the third DC voltage being applied, and then a fourth DC voltage being applied, the DC voltages do not necessarily need to be applied in this order. For example, once the first DC voltage is applied to the first bias terminal, any of the second, third, or fourth DC voltages may be applied to the second bias terminal to generate a desired capacitance between the first RF terminal and the second RF terminal of the variable capacitance assembly. Further, when a variable capacitance assembly includes more than three EMS varactors, further DC voltages may be applied to the second bias terminal (again, after a first DC voltage has been applied to the first bias terminal) to generate a desired capacitance between the first RF terminal and the second RF terminal of the variable capacitance assembly. With more EMS varactors included in a variable capacitance assembly, the capacitance tuning range of the variable capacitance assembly may be greater and/or the capacitance tuning resolution of the variable capacitance assembly may be better.

Further, while FIGS. 10A, 10B, 11, 13A, and 13B show examples of two different EMS varactor designs that may be included in a variable capacitance assembly, other 3-metal layer, 4-terminal EMS varactor designs are possible.

A variable capacitance assembly, as disclosed herein, may be implemented with a closed-loop control circuit. For example, a closed-loop control circuit may include voltage meter, a capacitor meter, a high-voltage charge pump, and a digital-to-analog controller, each of which may be coupled to a variable capacitance assembly.

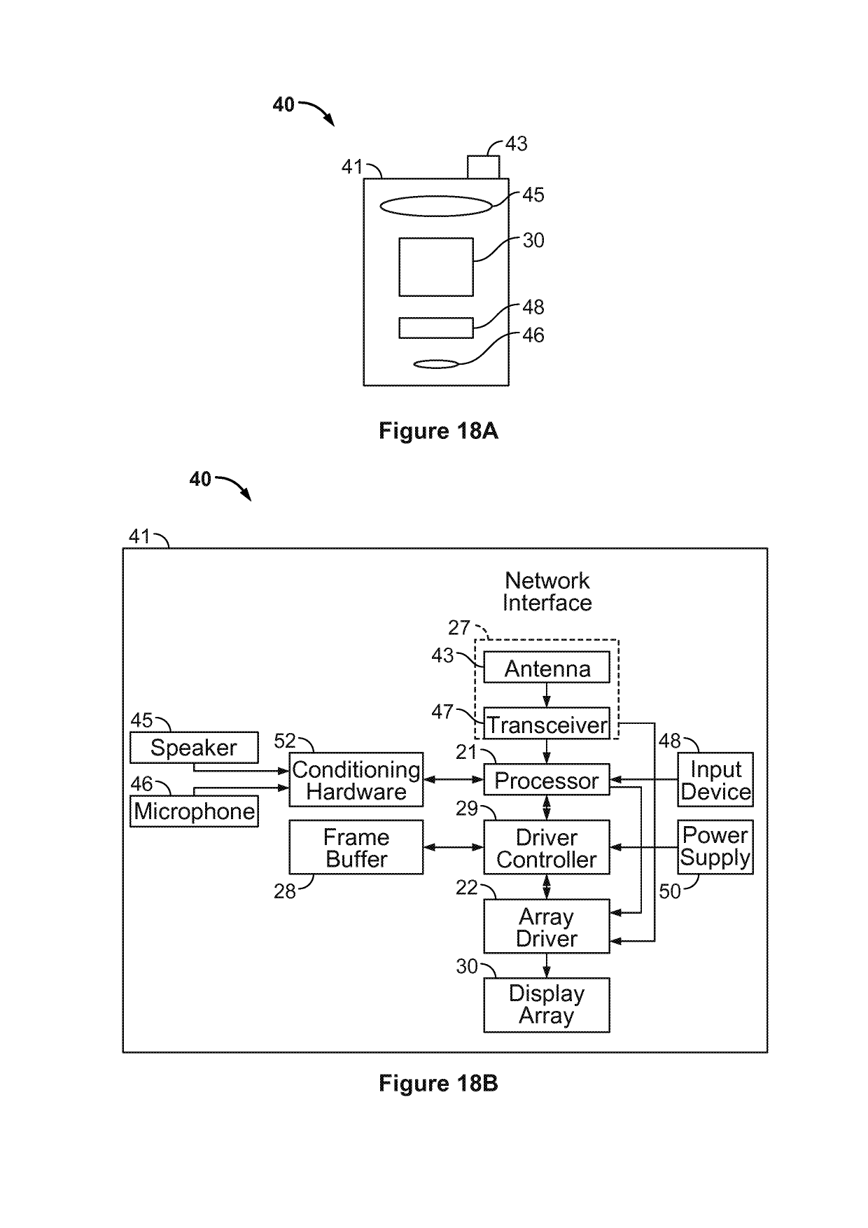

FIGS. 18A and 18B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a plurality of electromechanical systems varactors connected in parallel, each of the plurality of electromechanical systems varactors including:
a first metal layer, the first metal layer including a first bias electrode;
a second metal layer spaced apart from the first metal layer, the second metal layer including a first radio frequency electrode, the second metal layer and the first metal layer defining a first air gap; and
a third metal layer spaced apart from the second metal layer, the third metal layer including a second radio frequency electrode and a second bias electrode, the third metal layer and the second metal layer defining a second air gap;
wherein the second bias electrode of each of the plurality of electromechanical systems varactors has a different projected area perpendicular to a surface of the second metal layer and onto the surface of the second metal layer.

2. The apparatus of claim 1, wherein, when a first direct current voltage is applied to the first bias electrode of each of the plurality of electromechanical systems varactors, the first radio frequency electrode is configured to mechanically move to a first state, and wherein each of the plurality of electromechanical systems varactors is characterized by a different second direct current voltage applied to the second bias electrode to mechanically move the first radio frequency electrode from the first state to a second state.

3. The apparatus of claim 1, further comprising:
a first radio frequency terminal electrically connected to the first radio frequency electrode of each of the plurality of electromechanical systems varactors;
a second radio frequency terminal electrically connected to the second radio frequency electrode of each of the plurality of electromechanical systems varactors;
a first bias terminal electrically connected to the first bias electrode of each of the plurality of electromechanical systems varactors; and
a second bias terminal electrically connected to the second bias electrode of each of the plurality of electromechanical systems varactors.

4. The apparatus of claim 3, wherein the second radio frequency terminal is configured to receive a radio frequency signal, wherein the first radio frequency terminal is configured to vary a capacitance observed by the radio frequency signal received by the second radio frequency terminal, wherein the first bias terminal is configured to receive a first direct current voltage, and wherein the second bias terminal is configured to receive a second direct current voltage.

5. The apparatus of claim 3, wherein the first radio frequency terminal is configured to receive a radio frequency signal, wherein the second radio frequency terminal is configured to vary a capacitance observed by the radio frequency signal received by the first radio frequency terminal, wherein the first bias terminal is configured to receive a first direct current voltage, and wherein the second bias terminal is configured to receive a second direct current voltage.

6. The apparatus of claim 1, wherein the apparatus is configured as one of a tunable filter, a tunable resonator, or a tunable antenna.

7. The apparatus of claim 1, wherein each electromechanical systems varactor of the plurality of electromechanical systems varactors further includes:
an encapsulation shell, wherein the encapsulation shell includes a non-planarized dielectric layer on the third metal layer.

8. The apparatus of claim 1, wherein each electromechanical systems varactor of the plurality of electromechanical systems varactors further includes:
a substrate, wherein the third metal layer is on the substrate.

9. The apparatus of claim 1, wherein each electromechanical systems varactor of the plurality of electromechanical systems varactors further includes:
a substrate, wherein the first metal layer is on the substrate.

10. The apparatus of claim 1, wherein each electromechanical systems varactor of the plurality of electromechanical systems varactors further includes:
a non-planarized first dielectric layer between the first metal layer and the second metal layer.

11. The apparatus of claim 1, wherein each electromechanical systems varactor of the plurality of electromechanical systems varactors further includes:
a second dielectric layer between the second metal layer and the third metal layer.

12. A system comprising the apparatus of claim 1, the system further comprising:
a display;
a processor that is configured to communicate with the display, the processor being configured to process image data; and
a memory device that is configured to communicate with the processor.

13. The system of claim 12, further comprising:
a driver circuit configured to send at least one signal to the display; and
a controller configured to send at least a portion of the image data to the driver circuit.

14. The system of claim 12, further comprising:
an image source module configured to send the image data to the processor.

15. The system of claim 14, wherein the image source module includes at least one of a receiver, transceiver, and transmitter.

16. The system of claim 12, further comprising:
an input device configured to receive input data and to communicate the input data to the processor.

17. An apparatus comprising:
a plurality of electromechanical systems varactors connected in parallel, each of the plurality of electromechanical systems varactors including:
a first metal layer, the first metal layer including a first bias electrode;
a second metal layer spaced apart from the first metal layer, the second metal layer including a first radio frequency electrode, the second metal layer and the first metal layer defining a first air gap; and
a third metal layer spaced apart from the second metal layer, the third metal layer including a second radio frequency electrode and a second bias electrode, the third metal layer and the second metal layer defining a second air gap;
a first radio frequency terminal electrically connected to the first radio frequency electrode of each of the plurality of electromechanical systems varactors;
a second radio frequency terminal electrically connected to the second radio frequency electrode of each of the plurality of electromechanical systems varactors;
a first bias terminal electrically connected to the first bias electrode of each of the plurality of electromechanical systems varactors; and
a second bias terminal electrically connected to the second bias electrode of each of the plurality of electromechanical systems varactors;
wherein the second bias electrode of each of the plurality of electromechanical systems varactors has a different projected area perpendicular to a surface of the second metal layer and onto the surface of the second metal layer, and wherein when a first direct current voltage is applied to the first bias terminal, the first radio frequency electrode of each of the plurality of electromechanical systems varactors is configured to mechanically move to a first state, and wherein each of the plurality of electromechanical systems varactors is characterized by a different second direct current voltage applied to the second bias terminal to mechanically move the first radio frequency electrode from the first state to a second state.

18. The apparatus of claim 17, wherein the second radio frequency terminal is configured to receive a radio frequency signal, and wherein the first radio frequency terminal is configured to vary a capacitance observed by the radio frequency signal received by the second radio frequency terminal.

19. The apparatus of claim 17, wherein the first radio frequency terminal is configured to receive a radio frequency signal, and wherein the second radio frequency terminal is configured to vary a capacitance observed by the radio frequency signal received by the first radio frequency terminal.

20. A method of fabricating a variable capacitance apparatus, comprising:
forming a first bias electrode on a substrate for one of a plurality of electromechanical systems varactors;
forming a non-planarized first dielectric layer on the first bias electrode for the one of the plurality of electromechanical systems varactors;
forming a first sacrificial layer on the non-planarized first dielectric layer without planarizing the first dielectric layer for the one of the plurality of electromechanical systems varactors;
forming a first radio frequency electrode on the first sacrificial layer for the one of the plurality of electromechanical systems varactors;
forming a second sacrificial layer on the first radio frequency electrode for the one of the plurality of electromechanical systems varactors;
forming a second radio frequency electrode on the second sacrificial layer for the one of the plurality of electromechanical systems varactors;
forming a second bias electrode on the second sacrificial layer for the one of the plurality of electromechanical systems varactors; and
removing the first sacrificial layer and the second sacrificial layer for the one of the plurality of electromechanical systems varactors,
wherein the second bias electrode of each of the plurality of electromechanical systems varactors has a different projected area perpendicular to a surface of the first radio frequency electrode, and onto the surface of the first radio frequency electrode.

21. The method of claim 20, further comprising:
forming a non-planarized second dielectric layer on the second bias electrode and the second radio frequency electrode for the one of the plurality of electromechanical systems varactors.

22. The method of claim 20, wherein the first dielectric layer is formed with at least one of a physical vapor deposition process, a chemical vapor deposition process, and an atomic layer deposition process.
